(19) United States
(12) Patent Application Publication
(10) Pub. No.: US 2014/0023906 A1
(43) Pub. Date: Jan. 23, 2014

(54) POWER SUPPLY APPARATUS AND VEHICLE HAVING THE SAME

(71) Applicants: Hiroyuki Hashimoto, Hyogo (JP); Masaki Tsuchiya, Hyogo (JP); Yasuhiro Asai, Hyogo (JP); Takashi Seto, Hyogo (JP); Takahide Komoriya, Hyogo (JP)

(72) Inventors: Hiroyuki Hashimoto, Hyogo (JP); Masaki Tsuchiya, Hyogo (JP); Yasuhiro Asai, Hyogo (JP); Takashi Seto, Hyogo (JP); Takahide Komoriya, Hyogo (JP)

(21) Appl. No.: 14/007,360

(22) PCT Filed: Mar. 29, 2012
(86) PCT No.: PCT/JP2012/058482

§ 371 Date: Sep. 25, 2013

(30) Foreign Application Priority Data
Mar. 31, 2011 (JP) 2011-081314

(51) Int. Cl. H01M 2/10

(52) U.S. Cl. CPC H01M 2/1094; H01M 2/1083
USPC 429/120; 429/157

(57) ABSTRACT

A power supply apparatus includes: a battery cell stack obtained by stacking a plurality of battery cells; and a cover case surrounding an outside of the battery cell stack, in which a resin is poured between the battery cell stack and the cover case, achieving a waterproof structure of making the battery cell stack waterproof. This allows prevention of water entering from an outside, thereby preventing unintentional electric conduction or corrosion. A gap between the battery cell stack and the cover case is also eliminated to prevent the harmful influence on the battery cell stack due to condensation inside the cover case.

### BACKGROUND OF THE INVENTION

1. Field of the Invention

The present invention mainly relates to a power supply apparatus for a large current that is used for a power supply of a motor driving an automobile such as a hybrid automobile or an electric automobile, for household use, for electrical storage in industrial use or the like, and a vehicle having the same.

2. Description of the Related Art

A power supply apparatus having an output increased such as a battery pack for vehicles has been demanded. In such a power supply apparatus, an output voltage and an output power are increased by connecting a large number of battery cells in series. The battery cell is charged or discharged with a large current, leading to heat generation. In particular, an amount of the heat generation increases in accordance with an increase of the number of battery cells to be used. Therefore, demanded is a heat radiation mechanism in which heat radiated from the battery cell is efficiently subjected to thermal conduction for emission. As such a heat radiation mechanism, in addition to an air cooling system supplying cooling air to the battery cell, a direct cooling system employing heat exchange has been proposed in which a cooling pipe having a refrigerant supplied thereto and circulated therein comes into contact with the battery cell (for example, see Japanese Patent Laid-Open No. 2009-134901; Japanese Patent Laid-Open No. 2009-134936; Japanese Patent Laid-Open No. 2010-15788). As shown in FIGS. 27 and 28, for example, in such a battery system, a cooling pipe 260 for circulating a refrigerant is provided on an under surface of a battery cell stack 205 obtained by stacking battery cells 201, and is connected to a cooling mechanism 269. The battery cell stack 205 therefore releases heat to be cooled via the cooling pipe 260. In an example of FIG. 27, the cooling pipe 260 is provided to extend in a direction intersecting with a stacked direction of the battery cells 201. Alternatively, in an example of FIG. 28, the cooling pipe 260 is provided to extend in a direction parallel with the stacked direction of the battery cells 201. Further, in an example of FIG. 29, the cooling plate 261 is provided on the under surface of the battery cell stack 205, and then, the cooling pipe 260 is provided on the cooling plate 261. The battery cell stack 205 therefore releases heat to be cooled via the cooling plate 261.

As for these cooling systems, the heat exchange using a refrigerant can efficiently takes heat from the battery cell compared with the air cooling system supplying cooling air to gaps among adjacent battery cells. On the contrary, a temperature of a cooled part becomes comparatively low due to high cooling performance. Consequently, the temperature may decrease to not more than the dew point to cause the cooled water in the air to condense on a surface of the battery cell. Such condensation may unintentionally turn on electricity or cause corrosion.

See Japanese Utility Model Publication No. 34-16929; Japanese Patent Laid-Open No. 2005-149837; Japanese Patent Laid-Open No. 2002-100407.

The present invention has been made in order to solve these conventional problems. A main object of the present invention is to provide a power supply apparatus with which safety and reliability is enhanced by preventing condensation formed on a surface of a battery cell, and a vehicle having the same.

### SUMMARY OF THE INVENTION

In order to achieve the above object, according to a power supply apparatus of a first aspect of the present invention, the power supply apparatus includes: a battery cell stack obtained by stacking a plurality of battery cells; and a cover case surrounding an outside of the battery cell stack, wherein a resin can be poured between the battery cell stack and the cover case, achieving a waterproof structure of making the battery cell stack waterproof. This allows prevention of water entering from an outside, thereby preventing unintentional electric conduction or corrosion. A gap between the battery cell stack and the cover case can also be eliminated to prevent the harmful influence on the battery cell stack due to condensation inside the cover case.

According to a power supply apparatus of a second aspect, the resin can be a urethane-based resin.

According to a power supply apparatus of a third aspect, the power supply apparatus includes: a battery cell stack obtained by stacking a plurality of battery cells; and a cover case surrounding an outside of the battery cell stack, wherein the battery cell stack is inserted into a waterproof bag having waterproof properties, followed by sealing the waterproof bag, thereby achieving a waterproof structure of making the battery cell stack waterproof. A water drop is therefore prevented from entering by covering a surface of the battery cell stack with the waterproof bag, achieving the waterproof structure of the battery cell stack.

According to a power supply apparatus of a fourth aspect, an opening is provided on a part, while the opening can be blocked by an air permeable waterproof sheet having air permeability and waterproof properties, thereby achieving the waterproof structure. The waterproof structure of the battery cell stack can therefore be maintained. Further, when high-pressure gas is generated inside the rectangular battery cell, the gas can be released outside from the waterproof structure body via the air permeable waterproof sheet.

According to a power supply apparatus of a fifth aspect, the cover case includes a plurality of case members and each case member can be provided with a fitting portion for airtightly sealing the case members each other.

According to a power supply apparatus of a sixth aspect, the fitting portion can be sealed by a packing, an O-ring or a gasket.

According to a power supply apparatus of a seventh aspect, the power supply apparatus includes: a battery cell stack obtained by stacking a plurality of rectangular battery cells; and a cover case surrounding an outside of the battery cell stack, wherein a water absorption sheet having water-absorbing properties can be provided between the battery cell stack and the cover case. The harmful influence on the battery cell stack can therefore be prevented by causing the water absorption sheet to absorb water even when the condensation is formed inside the cover case or water enters the cover case. In particular, the condensation can be prevented with a simple configuration and a low cost without a complicated process such as potting.

According to a power supply apparatus of an eighth aspect, the power supply apparatus can further include: a cooling plate provided on one surface of the battery cell stack to be thermally coupled with the battery cell stack, the cooling plate performing heat exchange with the battery cell stack by flowing a refrigerant thereinside. Therefore, the battery cell stack can be efficiently cooled from the one surface by the cooling plate, as well as the condensation due to the difference in temperature is prevented with the battery cell stack having the waterproof structure. Consequently, the reliability can be enhanced by preventing the unintentional electric conduction or corrosion.

According to a power supply apparatus of a ninth aspect, the power supply apparatus can further include: a thermal conductive sheet provided between one surface of the battery cell stack and the cooling plate, the thermal conductive sheet having insulating properties. Therefore, the thermal coupling between the battery cell stack and the cooling plate can be favorably improved.

As for a vehicle having a power supply apparatus of a tenth aspect, the above power supply apparatus can be applied thereto.

### BRIEF DESCRIPTION OF THE DRAWINGS

FIG. 1 is an exploded perspective view of a power supply apparatus having a power supply apparatus according to Embodiment 1 of the present invention.

FIG. 2 is a perspective view of a battery pack in FIG. 1.

FIG. 3 is an exploded perspective view illustrating a battery cell stack in FIG. 2 having a cooling plate removed therefrom.

FIG. 4 is a perspective view of the battery cell stack in FIG. 2 diagonally viewed from a lower part.

FIG. 5 is an exploded perspective view of the battery pack in FIG. 2.

FIG. 6 is an exploded perspective view of a battery cell stack in FIG. 5.

FIG. 7 is a perspective view of an inner case.

FIG. 8 is an exploded perspective view illustrating a state where the battery cell stack in FIG. 6 is inserted into the inner case in FIG. 7.

FIG. 9 is a schematic sectional view illustrating an example of providing a water absorption sheet on the battery cell stack.

FIG. 10 is a perspective view illustrating a cover case in FIG. 8 having a urethane-based resin poured therein.

FIG. 11 is a schematic plan view illustrating how the cooling plate is provided.

FIG. 12A is a schematic sectional view of a battery cell stack having a cooling pipe provided on an under surface, and FIG. 12B is a schematic sectional view of a battery cell stack according to a modified Embodiment.

FIG. 13 is a perspective view of a battery cell stack in a power supply apparatus according to Embodiment 2.

FIG. 14 is an exploded perspective view illustrating the battery cell stack in FIG. 13 having a cooling plate removed therefrom.

FIG. 15 is an exploded perspective view of the battery cell stack in FIG. 14.

FIG. 16 is an exploded perspective view of the battery cell stack in FIG. 15.

FIG. 17 is a vertical sectional view of the battery cell stack in FIG. 13.

FIG. 18 is an enlarged perspective sectional view illustrating a connection part between an inner case and a cover portion.

FIG. 19 is a perspective view of a battery cell stack according to Embodiment 3.

FIG. 20 is an exploded perspective view of the battery cell stack in FIG. 19.

FIGS. 21A and 21B show schematic exploded perspective views illustrating how a side surface of the battery cell is covered with a tubular heat shrinkable tube.

FIG. 22 is a schematic exploded perspective view illustrating how a battery cell stack according to Embodiment 4 is inserted into a waterproof bag.

FIG. 23 is a schematic exploded perspective view illustrating how a battery cell stack according to Embodiment 5 is inserted into a waterproof bag.

FIG. 24 is a block diagram illustrating an example in which a power supply apparatus is mounted on a hybrid automobile driven by an engine and a motor.

FIG. 25 is a block diagram illustrating an example in which a power supply apparatus is mounted on an electric automobile only driven by a motor.

FIG. 26 is a block diagram illustrating an example of an application to a power supply apparatus for storage of electricity.

FIG. 27 is a perspective view of a cooling mechanism in a conventional power supply apparatus.

FIG. 28 is a perspective view of a cooling mechanism in another conventional power supply apparatus.

FIG. 29 is a perspective view of a cooling mechanism in still another conventional power supply apparatus.

### DETAILED DESCRIPTION OF THE EMBODIMENT(S)

Hereinafter, an embodiment of the present invention will be described with reference to the drawings. The embodiment described below is deemed to be merely illustrative of a power supply apparatus and a vehicle having the same for giving a concrete form to the technical idea of the present invention, and therefore, the present invention does not limit the power supply apparatus and the vehicle having the same to the following. Further, components set forth in Claims are never limited to components in the embodiment. In particular, a size, a material, a shape, relative positioning or the like of the components described in the embodiment is not aimed at limiting the scope of the invention only thereto unless otherwise described but merely illustrative. A size, a positional relationship or the like of the components in the respective drawings may be exaggerated for clarifying the description. Further, in the following description, like or similar components are represented by like names and symbols, and therefore, detailed description is appropriately omitted. As for each component of the present invention, one member may serve as a plurality of components by forming the plurality of components with the same member. On the contrary, a function of one member may be shared among the plurality of members. Furthermore, details described in one embodiment may be applied to another embodiment or the like.

### Embodiment 1

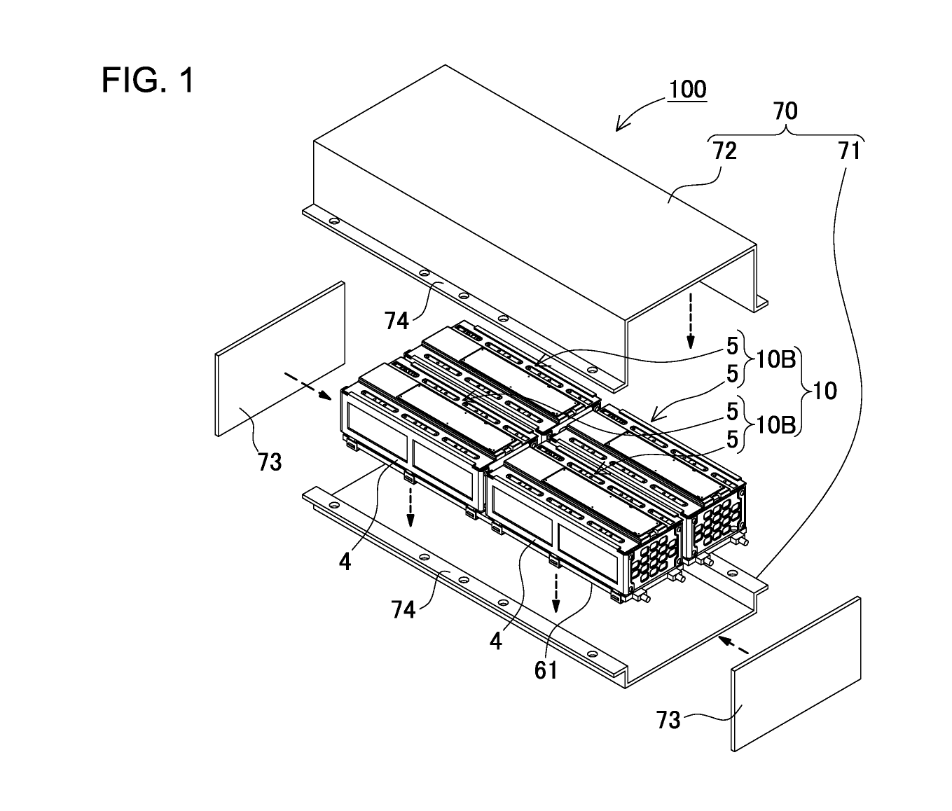

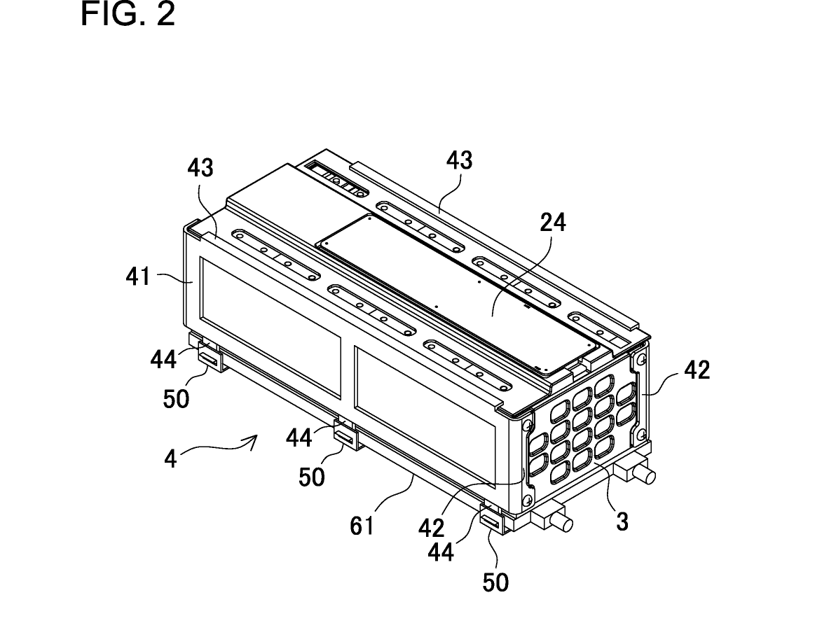

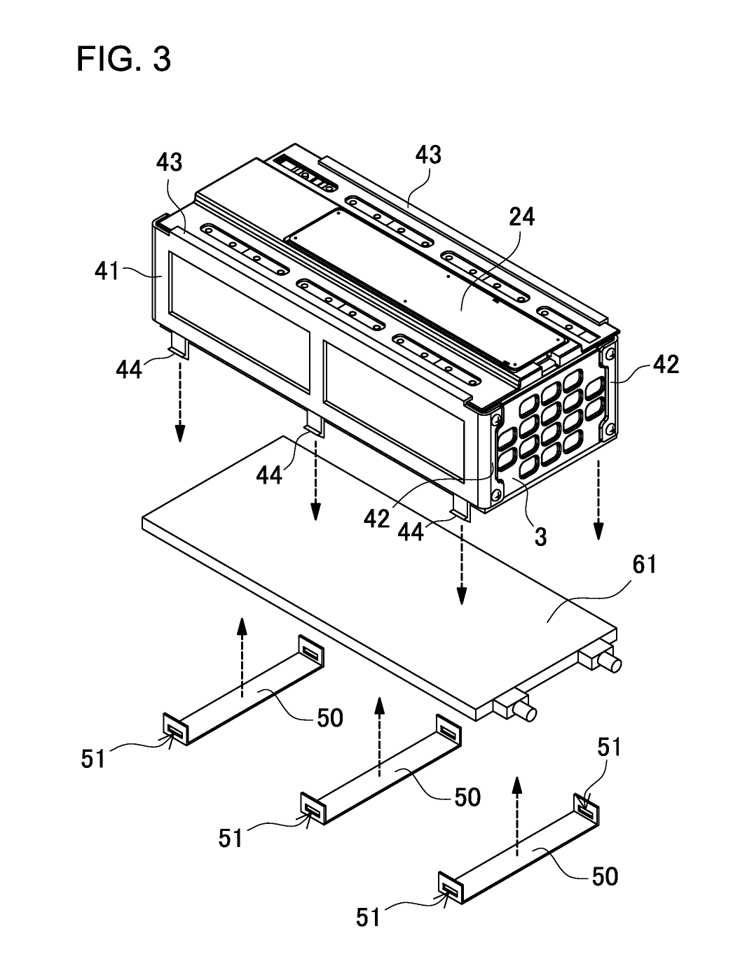

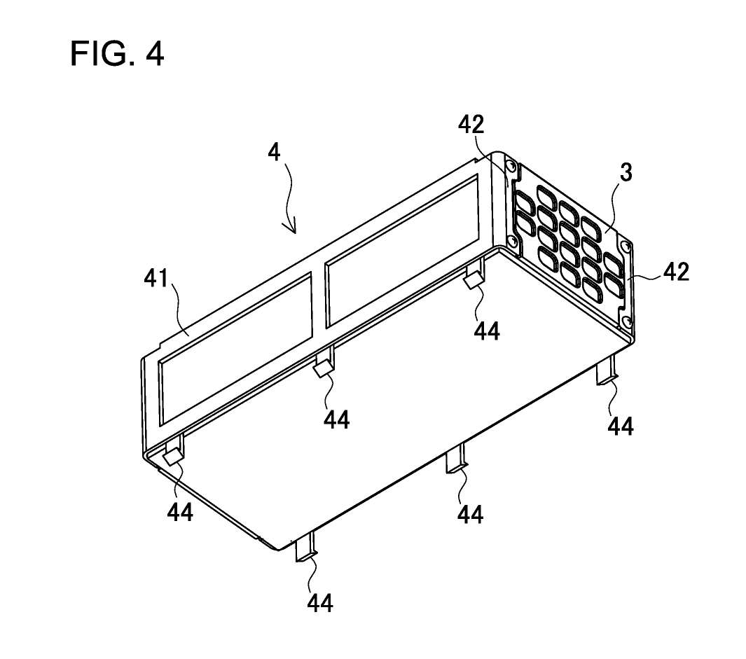

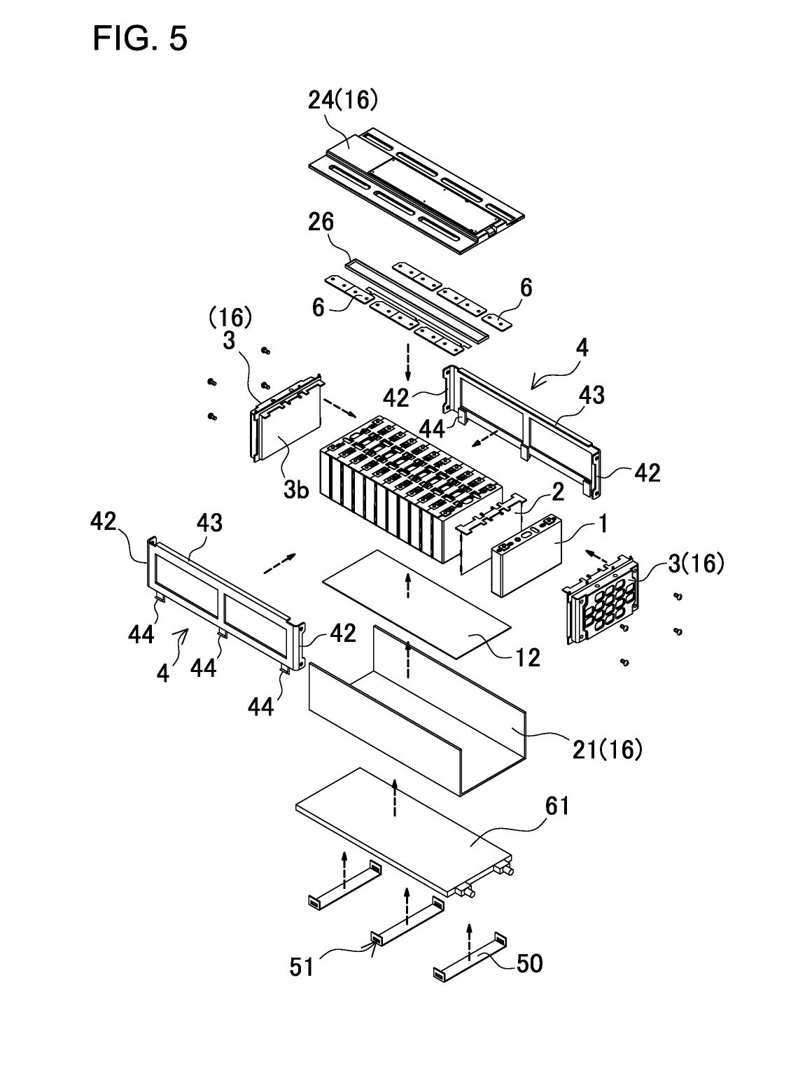

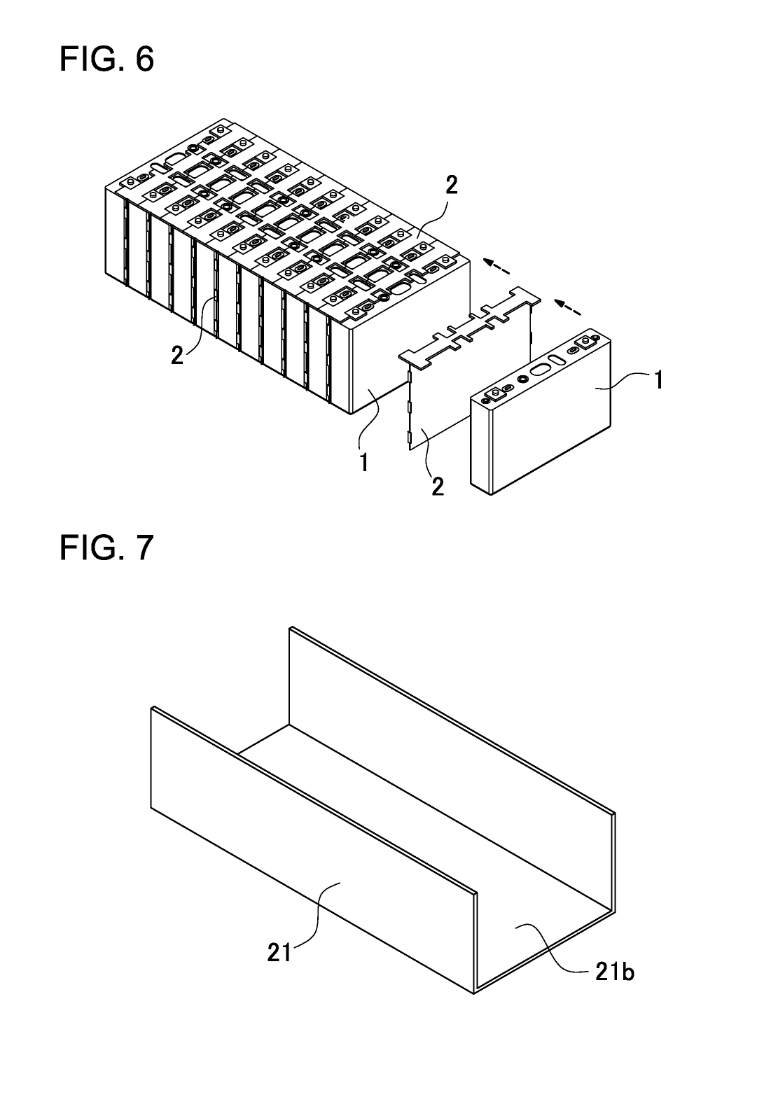

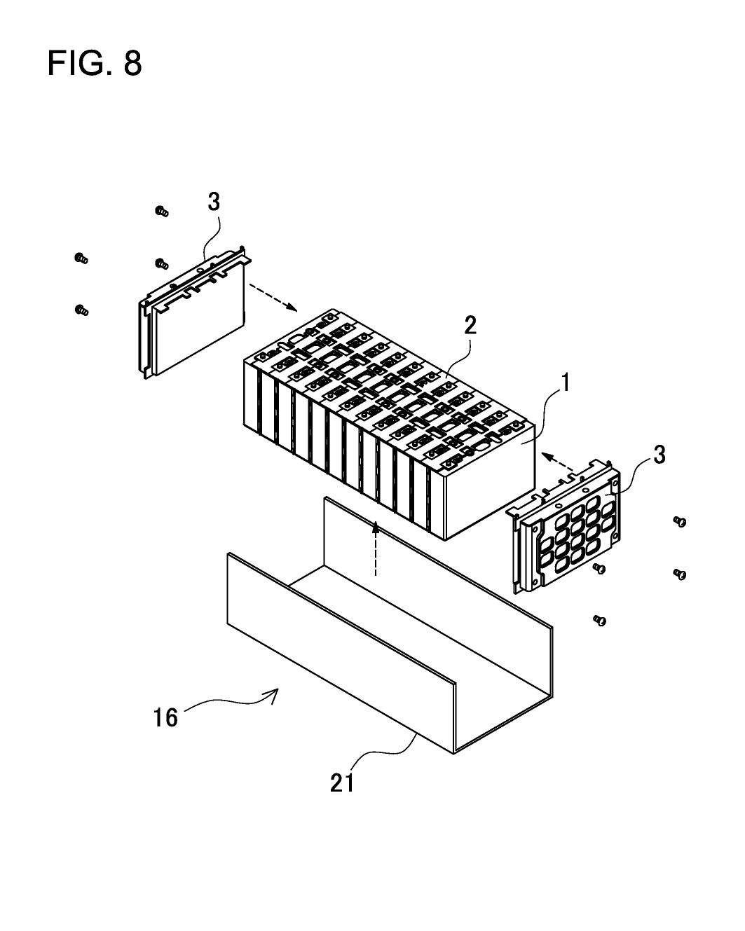

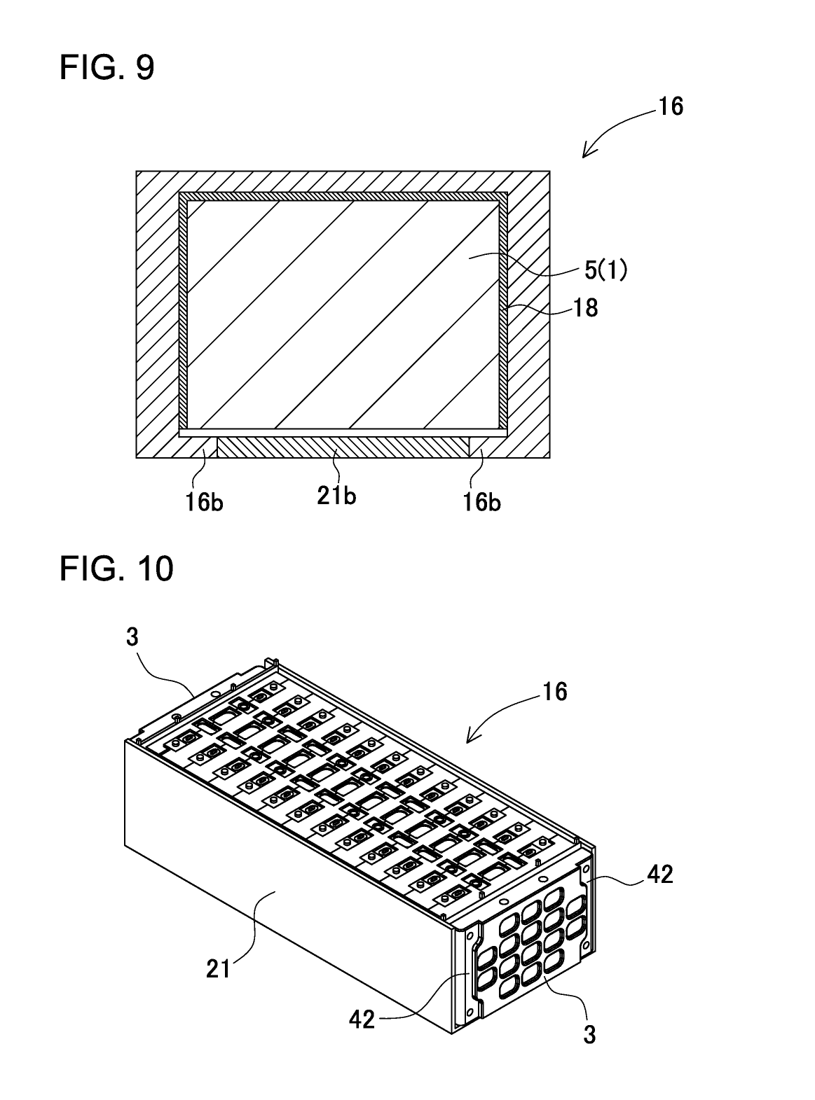

An example of a power supply apparatus 100 according to Embodiment 1 of the present invention applied to an on-board power supply apparatus will be described in FIGS. 1 to 10. In these figures, FIG. 1 is an exploded perspective view of the power supply apparatus 100, FIG. 2 is a perspective view of a battery cell stack 5 in FIG. 1, FIG. 3 is an exploded perspective view illustrating the battery cell stack 5 in FIG. 2 having a cooling plate 61 removed therefrom, FIG. 4 is a perspective view of the battery cell stack 5 in FIG. 2 diagonally viewed from a lower part, FIG. 5 is an exploded perspective view of the battery cell stack 5 in FIG. 2, FIG. 6 is an exploded perspective view of the battery cell stack 5 in FIG. 5, FIG. 7 is a perspective view of an inner case 21, FIG. 8 is an exploded perspective view illustrating a state where the battery cell stack 5 in FIG. 6 is inserted into the inner case 21 in FIG. 7, FIG. 9 is a schematic sectional view illustrating an example of providing a water absorption sheet between the battery cell stack 5 and a cover case 16, and FIG. 10 is a perspective view illustrating a cover case 16 in FIG. 8 having a urethane-based resin poured therein. The power supply apparatus 100 is used for a power supply that drives a vehicle by mainly being mounted on an electric vehicle such as a hybrid automobile or an electric automobile and by supplying electric power to a drive motor of the vehicle. The power supply apparatus of the present invention can also be used for an electric vehicle other than the hybrid automobile or the electric automobile, and further, for an application of requiring high power other than the electric vehicle.

### (Power Supply Apparatus 100)

An appearance of the power supply apparatus 100 is a box shape with a top surface rectangular as shown in the exploded perspective view of FIG. 1. In the power supply apparatus 100, a box-shaped outer case 70 is divided into two parts to house a plurality of battery packs 10 thereinside. The outer case 70 includes a lower case 71, an upper case 72, and end plates 73 connected to both ends of the lower case 71 and the upper case 72. The upper case 72 and the lower case 71 include flange portions 74 projecting outwardly, which flange portion 74 is fixed by a bolt and a nut. The flange portion 74 is provided on a side surface of the outer case 70. In an example of FIG. 1, the lower case 71 houses four battery cell stacks 5 in total; two in a longitudinal direction and two in a lateral direction. Each battery cell stack 5 is fixed in place inside the outer case 70. The end plates 73 are connected to the both ends of the lower case 71 and the upper case 72 to block both ends of the outer case 70.

### (Battery Pack 10)

In the example of FIG. 1, a battery pack 10 includes four battery cell stacks 5. That is, two battery cell stacks 5 are connected in a stacked direction of rectangular battery cells 1 to form one battery cell stack continuous body 10B. The battery pack 10 is formed by arranging two of the battery cell stack continuous bodies 10B in such a connection condition in parallel with each other.

FIG. 2 shows the perspective view of each battery cell stack of the battery pack 10. As shown in FIG. 3, the battery cell stack 5 is fixed to the cooling plate 61 for cooling the battery cell stack 5. In order to fix the battery cell stack 5 to the cooling plate 61, a connecting structure is provided as shown in FIGS. 2 to 5 (details will be described later).

### (Cover Case 16)

Each battery cell stack 5 is covered with the cover case 16. In Embodiment 1, the cover case 16 includes the inner case 21 with a section thereof U shaped, end plates 3 covering both ends of the inner case 21, and a cover portion 24 covering an upper surface, as shown in the exploded perspective view of FIG. 5. Here, the end plates 3 sandwiching the battery cell stack 5 from both ends also serve as ends of the cover case 16. A packing 3b is provided inside the end plate 3, as shown in FIG. 5. The packing 3b is a sheet-like elastic member. The battery cell stack 5 is covered with the cover case 16 in such a manner, achieving a leak proof structure. A projecting portion 16b for supporting a side edge of the battery cell stack 5 may be provided on a base of the cover case 16, as shown in the sectional view of FIG. 9 or the like.

As shown in FIG. 5, the battery cell stack 5 includes the plurality of rectangular battery cells 1, separators 2 each provided between stacked surfaces of the adjacent rectangular battery cells 1 and insulating the rectangular battery cells 1 from each other, the inner case 21 housing the battery cell stack 5 obtained by alternately stacking the plurality of rectangular battery cells 1 and separators 2, the pair of end plates 3 provided at the ends of the battery cell stack 5 in the stacked direction, and a plurality of metal fastening members 4 fastening the end plates 3 at the both ends of the battery cell stack 5.

### (Battery Cell Stack 5)

The battery cell stack 5 is obtained by stacking the plurality of rectangular battery cells 1 via the insulating separators 2, as shown in FIG. 6. Further, as shown in FIG. 5, the pair of end plates 3 is provided at the both ends of the battery cell stack 5, which end plates 3 are connected by the fastening members 4. In such a manner, the separator 2 insulating the rectangular battery cells 1 adjacent to each other is provided between stacked surfaces of the rectangular battery cells 1, thereby providing the battery cell stack 5 in which the plurality of rectangular battery cells 1 and separators 2 are alternately stacked.

### (Inner Case 21)

The inner case 21 is formed into the U shape with an upper part and the both ends opened, as shown in FIG. 7. An inner surface of the inner case 21 is insulated from the stacked rectangular battery cells 1. On the other hand, in order to cool the rectangular battery cells 1 by thermal coupling with the cooling plate 61, thermal conductivity needs to be increased in an interface with the cooling plate 61. In this example, since a bottom surface of the inner case 21 is the interface with the cooling plate 61, a bottom plate 21b of the inner case 21 is made of metal with a surface thereof insulated for increasing the thermal conductivity of the interface. Here, an aluminum plate of the bottom plate 21b is subjected to insert-molding with resin so that the aluminum plate is positioned at the bottom. A fiber sheet, a mica sheet or the like can be preferably used for the resin. Accordingly, the thermal conductivity of the bottom surface is increased, while a side surface has insulating properties. Alternatively, a thermal conductive sheet having insulating properties and thermal conductivity can also be provided on the bottom surface of the inner case, as required.

### (Rectangular Battery Cell 1)

In the rectangular battery cell 1, an outer can forming its outer shape is rectangular with a thickness thereof thinner than a width thereof. Positive and negative electrode terminals are provided on a sealing plate that blocks the outer can, as well as a safety valve is provided between the electrode terminals. The safety valve is opened when an internal pressure in the outer can increases to not less than a predetermined value, thereby allowing gas inside thereof to be released. Opening the safety valve enables the internal pressure in the outer can to stop increasing. A unit cell of the rectangular battery cell 1 is a rechargeable secondary battery cell such as a lithium ion battery cell, a nickel-metal hydride battery cell, and a nickel-cadmium battery cell. In particular, when a lithium ion secondary battery cell is used for the rectangular battery cell 1, a charging capacity with respect to volume or mass of the whole battery cell can be increased. Further, a battery cell in the present invention may be a cylindrical battery cell, or a rectangular or another shaped laminated battery cell having an outer body covered with a laminate material, not limited to the rectangular battery cell.

In each stacked rectangular battery cell 1 of the battery cell stack 5, the adjacent positive and negative electrode terminals are connected to each other in series by a bus bar 6. In the battery pack 10 having the adjacent rectangular battery cells 1 connected to each other in series, increasing an output voltage enables a large output. As for the battery pack, the adjacent rectangular battery cells can be connected in parallel with each other, or series connection can be combined with parallel connection, providing multi-series parallel connection or multi-parallel series connection. The rectangular battery cell 1 includes a metal outer can. The separator 2 of an insulating material is provided between the adjacent rectangular battery cells 1 to prevent a short circuit of the outer cans of the rectangular battery cells 1. The outer can of the rectangular battery cell may be made of an insulating material such as plastic. In this instance, the outer can of the rectangular battery cell does not need to be insulated for stacking. Therefore, the separator can be made of metal, or the separator itself may be no longer needed.

### (Separator 2)

The separator 2 is a spacer to be stacked for electrically and thermally insulating the adjacent rectangular battery cells 1. The separator 2 is made of an insulating material such as plastic. The separator 2 is provided between the adjacent rectangular battery cells 1 to insulate the adjacent rectangular battery cells 1.

Here, securing insulation between the inner case 21 and the rectangular battery cell 1 can simplify a side surface of the separator 2, leading to downsizing. That is, in examples of FIGS. 5 and 6, the side surface of the inner case 21 has insulating properties to be able to protect a side surface of the battery cell stack 5. The separator 2 is simply required to insulate only facing surfaces of the rectangular battery cells 1, and the side surface of the rectangular battery cell does not need to be covered with the separator. Therefore, a projecting part with which the side surface of the battery cell stack 5 is covered can be eliminated from the side surface of the separator, leading to downsizing. Alternatively, in order to hold and position the separator itself, a separator projecting slightly at a chamfer on the side surface of the rectangular battery cell can be used. Since this separator can lie in the substantially same plane as the surface of the rectangular battery cell on the side surface of the battery cell stack, a width of the battery cell stack can be reduced. Positioning among the separators can also be performed by providing a fitting structure employing projections and recesses or the like on a top surface of the separator. Meanwhile, a projecting part on the side surface of the separator is provided for positioning the battery cell to be stacked.

The whole inner case may be made of metal. In this instance, since the side surface of the inner case is also made of metal, the side surface of the rectangular battery cell is preferably covered with the separator in order to insulate between the rectangular battery cells on the side surface of the battery cell stack. On the other hand, the separator is not necessarily provided between the rectangular battery cells in the battery cell stack. For example, the adjacent rectangular battery cells are insulated by forming the outer can of the rectangular battery cell with an insulating material, or by covering an outer circumference of the outer can of the rectangular battery cell with a heat shrinkable tube, an insulating sheet, insulating paint or the like. Therefore, the separator can be no longer needed. In particular, the separator is not necessarily provided between the rectangular battery cells not in the air cooling system in which the rectangular battery cells are cooled by forcing cooling air to be supplied among the rectangular battery cells but in the system in which the battery cell stack is cooled via the cooling plate that is cooled by a refrigerant or the like. Further, in the system in which the battery cell stack is cooled via the cooling plate that is cooled by a refrigerant or the like, an air duct for supplying the cooling air to the insulating separator provided between the rectangular battery cells does not need to be provided, unlike the air cooling system in which the rectangular battery cells are cooled by forcing cooling air to be supplied among the rectangular battery cells. This enables reduction of a length of the rectangular battery cell in the stacked direction and downsizing of the battery cell stack.

### (End Plate 3)

As shown in FIG. 8, the pair of end plates 3 is provided at the both ends of the battery cell stack 5 obtained by alternately stacking the rectangular battery cells 1 and the separators 2, which pair of end plates 3 fastens the battery cell stack 5. The end plate 3 is made of a material having enough strength such as metal. The end plate 3 has a fixing structure for being fixed to the lower case 71 in FIG. 1.

### (Fastening Member 4)

As shown in FIGS. 2 to 5, the fastening members 4 fasten the battery cell stack 5 by being provided on the both side surfaces of the battery cell stack 5 having the end plates 3 stacked at the both ends, and by being fixed to the pair of end plates 3. As shown in the perspective view of FIG. 5, the fastening member 4 includes a body portion 41 covering the side surface of the battery cell stack 5, bent pieces 42 bent at both ends of the body portion 41 and fixed to the end plates 3, a top-surface holding portion 43 having an upper part bent and holding the top surface of the battery cell stack 5, and fastening connecting portions 44 projecting downwardly. Such a fastening member 4 is formed with a bind bar made of a material having enough strength such as metal. In the example of FIG. 1, each battery cell stack is provided with the fastening members, and in such an instance, the end plates at the both ends in each battery cell stack are fixed by the fastening members. Alternatively, two of the battery cell stacks are arranged in the stacked direction, and then the both side surfaces can be integrally connected by the fastening members. In this configuration, the fastening member can also be used as a member for connecting the battery cell stacks each other. Here, the end plates at both ends are fixed by the fastening members, while the fastening members are not fixed to the end plates facing each other between the two battery cell stacks. Further, the end plates facing each other between the two battery cell stacks can be formed as one part for sharing. Fixing between the end plates and the fastening members is not limited to the structure of fixing with a bolt or the like described in the embodiment.

### (Waterproof Structure)

A circumference of the battery cell stack 5 is made waterproof by the cover case 16. This allows prevention of water entering from an outside, thereby preventing unintentional electric conduction or corrosion. On the other hand, the battery cell stack 5 needs to be protected not only from the water entering from the outside but also from a water drop generated due to the inside condensation. In particular, as a cooling system for the rectangular battery cells, when the cooling system in which heat of the rectangular battery cell is taken by heat exchange using a refrigerant is employed, cooling can be more efficiently performed. On the contrary, a temperature decreases to not more than the dew point due to high cooling performance. This may cause the cooled water in the air surrounding the battery cell stack to condense on a surface of the rectangular battery cell. Therefore, not only the cover case 16 has the waterproof structure, but also a waterproof structure for protecting the surface of the battery cell stack 5 surrounded by the cover case 16 from such a water drop is employed.

### (Cushioning Member 18)

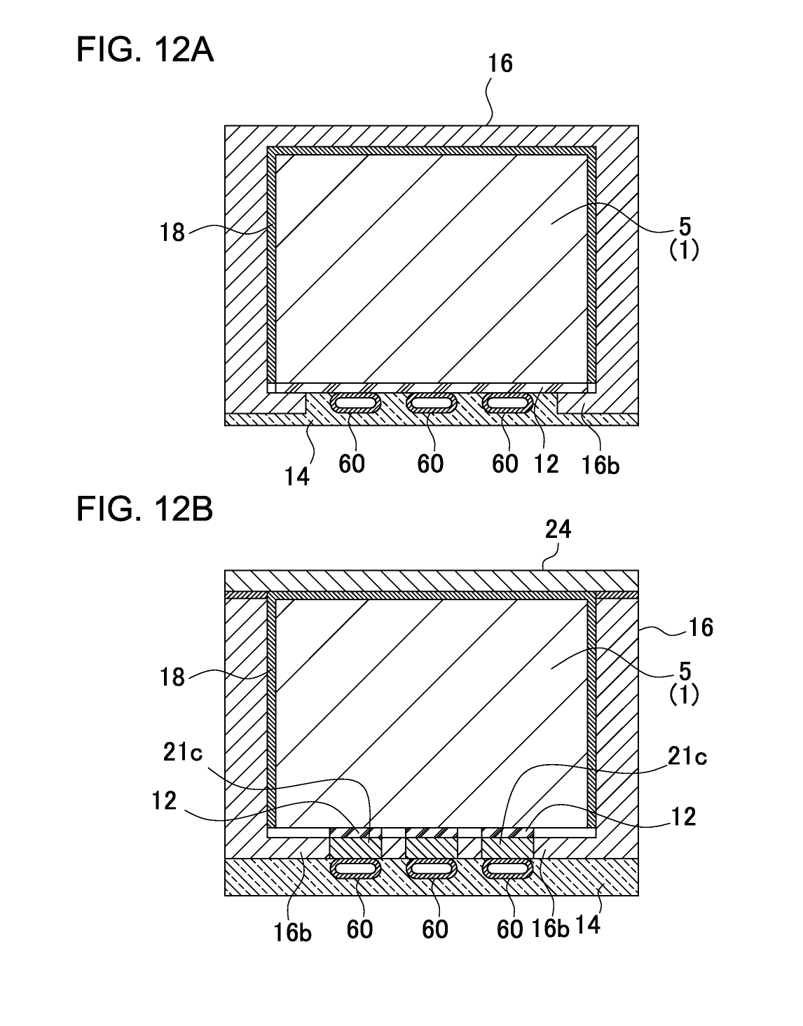

In order to achieve such a waterproof structure of the battery cell stack 5, a cushioning member 18 is provided between the battery cell stack 5 and the cover case 16 in a modified embodiment shown in the sectional views of FIG. 9 and FIGS. 12A, 12B. That is, a gap between the battery cell stack 5 and the cover case 16 is filled with the cushioning member 18 to prevent a harmful influence on the battery cell stack 5 due to the condensation of water in the air existing in the gap.

In the example of Embodiment 1, the circumference of the battery cell stack 5 is covered with resin as the cushioning member 18. Here, in order to hold the resin on the surface of the battery cell stack 5, the circumference of the battery cell stack 5 is surrounded by the cover case 16 to pour the resin between the battery cell stack 5 and the cover case 16. The space between the battery cell stack 5 and the cover case 16 is therefore eliminated to prevent the harmful influence due to the condensation formed on the surface of the battery cell stack 5. In Embodiment 1, in order to achieve the waterproof structure with the end plates 3 and the inner case 21, after the fastening by the fastening members 4, a gap between the battery cell stack 5 and the cover case 16 is filled with a filling material as the cushioning member 18 in a region surrounded by the end plates 3 and the inner case 21. Consequently, the waterproof structure of making the circumference of the battery cell stack 5 waterproof can be obtained, as shown in FIG. 10.

### (Filling Material)

Urethane-based resin can be preferably used as a filling material. Potting with the filling material in such a manner can eliminate the space, protect the surface of the rectangular battery cell 1, and prevent the electric conduction or corrosion due to the condensation. Preferably, a pressure is reduced or a negative pressure is formed inside the inner case 21 at the time of filling for spreading the filling material over the gap and preventing generation of an air bubble. On the contrary, a pressure can be applied to the resin, followed by pouring. After the filling with the resin, the resin is dried until being completely cured.

### (Water Absorption Sheet)

A water absorption sheet can also be used as the cushioning member 18. The water absorption sheet is a hygroscopic and water-absorbing sheet material of a polymeric material or the like. The water absorption sheet can prevent the condensation with a simple configuration and a low cost without a complicated process such as the potting. Further, the cushioning member 18 is not limited thereto. A sealing structure using a packing, an O-ring, a gasket or the like, a sheet-like elastic member or another potting material, or a configuration of, for example, housing the battery cell stack in a waterproof bag can be appropriately employed.

### (Cover Portion 24)

After the filling with the filling material, the top surface is blocked with the cover portion 24, as shown in FIG. 3. Here, the cover portion 24 is fixed to the top surface of the inner case 21 via a packing or the like. A gas duct 26 communicating with the safety valve of the rectangular battery cell 1 is provided on an inner surface of the cover portion 24. The gas duct 26 communicates with the safety valve of each rectangular battery cell 1 and is provided outside, and therefore, gas released at the time of increasing the internal pressure of the rectangular battery cell 1 can be safely released outside. Further, the bus bar 6 can be insert-molded to the cover portion 24. Therefore, the electrode terminals of the respective rectangular battery cells 1 can be connected all together by joining the cover portion 24 to the top surface of the battery cell stack 5. Furthermore, a circuit board including a control circuit for controlling the power supply apparatus 100 is provided on a top surface of the cover portion 24. Alternately, the circuit board may be integrally provided on the cover portion.

The cover case 16 houses the battery cell stack 5 in this manner. In the cover case 16, a fitted portion can also be airtightly sealed with a case member of each surface as a fitting structure. A packing, an O-ring, a gasket or the like can be used for such a fitting structure, thereby enabling the sealing of the cover case 16.

### (Connection Structure)

Meanwhile, the battery cell stack 5 and the cooling plate 61 have a connection structure for fixing the battery cell stack 5 to the cooling plate 61. As shown in the examples of FIGS. 2 to 5, the connection structure includes the fastening connecting portions 44 projecting from a lower end of the body portion 41 of the fastening member 4, and plate connecting portions provided on the cooling plate 61. The plurality of fastening connecting portions 44 are provided to keep a distance from each other. In the example of FIG. 2, the fastening connecting portions 44 are provided on three parts at both sides and in the middle of a lower end of the body portion 41.

### (Engaging Piece)

The fastening connecting portion 44 is an engaging piece having a tip formed into a hook shape in the examples of FIGS. 3 and 4. In the engaging piece, the hook-like tip projects outwardly from the battery cell stack 5.

### (Plate Connecting Portion)

Meanwhile, the plate connecting portions are provided as a connection mechanism for connection with the fastening connecting portions 44 on the cooling plate 61. The plate connecting portions are provided at positions corresponding to positions of the fastening connecting portions 44. As such a plate connecting portion, a connecting bar 50 having engaging holes 51 capable of being engaged with the engaging piece formed therein is employed in the example of FIG. 5. The fastening member 4 can be easily fixed to the cooling plate 61 by inserting the hook-like engaging piece in the engaging hole 51 for engagement.

### (Connecting Bar 50)

As shown in the exploded perspective view of FIG. 5, the connecting bar 50 has a shape obtained by bending a strip with a section having a substantially U shape. The strip is made of a metal plate for having enough strength. In the example of FIG. 5, a step is formed on a surface of the strip to improve the strength. A length of the connecting bar 50 is long enough to hold a bottom surface of the cooling plate 61 with the bent portions in the substantially U shape. The engaging hole 51 is opened as the plate connecting portion at an end of the connecting bar 50. As described above, the plate connecting portion can be easily added to the cooling plate 61 by using the connecting bar 50. In particular, the connection mechanism can be added without complicating the shape of the cooling plate 61 having a function of circulating a refrigerant or the like.

### (Refrigerant Circulation Mechanism)

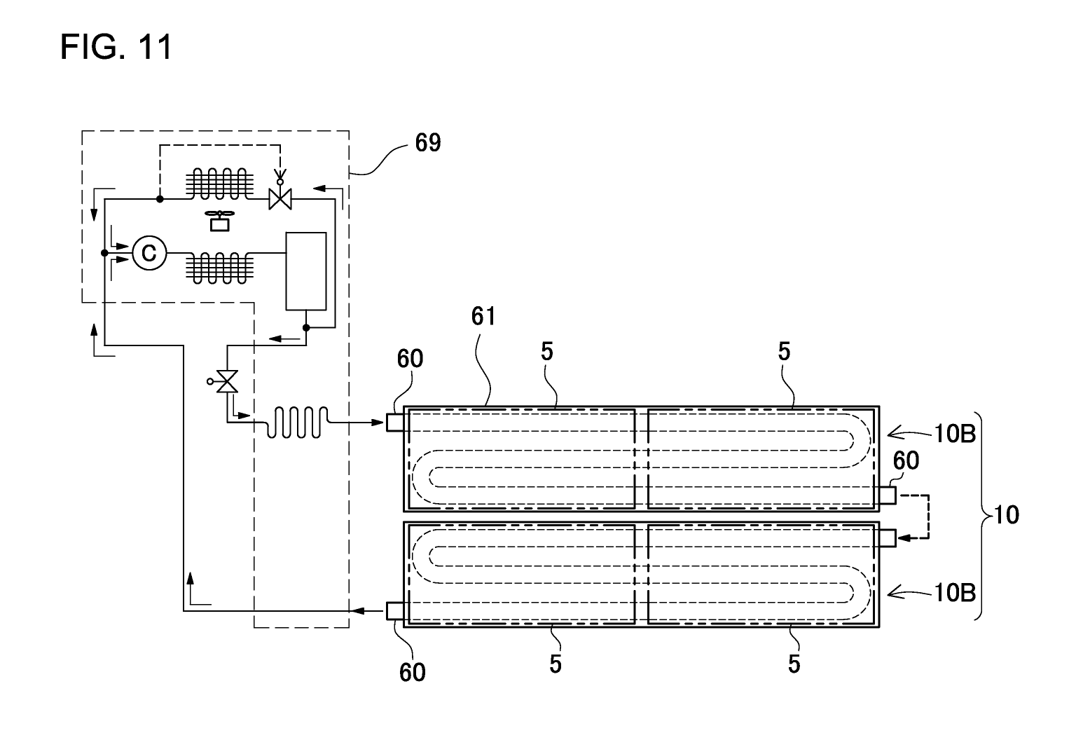

The cooling plate 61 is provided with a refrigerant circulation mechanism thereinside. FIG. 11 shows one example of such a refrigerant circulation mechanism. In the battery pack 10 of FIG. 11, the battery cell stack 5 obtained by stacking the plurality of rectangular battery cells 1 is provided on the top surface of the cooling plate 61. The cooling plate 61 is thermally coupled with the rectangular battery cells 1 of the battery cell stack 5. The cooling plate 61 is provided with a refrigerant pipe that is connected to a cooling mechanism 69. In the battery pack 10, the battery cell stack 5 can be directly and effectively cooled by coming into contact with the cooling plate 61. Further, not only the battery cell stack but also respective members provided on the end of the battery cell stack, for example, can also be cooled. The cooling plate 61 including the cooling pipe 60 having a refrigerant circulated therein comes into contact with the bottom plate 21b of the cover case 16, followed by cooling in such a manner. Therefore, heat dissipation is increased, allowing the power supply apparatus to be stably used even with high power.

### (Cooling Plate 61)

The cooling plate 61 is a radiator for conducting heat of the rectangular battery cell 1 and radiating the heat outside, and is provided with the refrigerant pipe in the example of FIG. 11. As a heat exchanger, the cooling plate 61 includes the cooling pipe 60 of a refrigerant pipe circulating cooling liquid of a refrigerant and made of copper, aluminum or the like. The cooling pipe 60 is thermally coupled with a top plate of the cooling plate 61, while a heat insulating material is provided between the cooling pipe 60 and a bottom plate of the cooling plate 61 to insulate therebetween. The cooling plate 61 can also be made of only a metal plate other than adding the cooling function using such a refrigerant thereto. For example, a shape excellent in heat radiation and thermal conductivity such as a metal body with a radiation fin is employed. Alternately, a thermal conductive sheet having insulating properties may be used, not limited to the metal.

The cooling plate 61 is cooled by supplying cooling liquid from the cooling mechanism 69 to the refrigerant pipe provided thereinside. The cooling plate 61 can more efficiently perform cooling with the cooling liquid supplied from the cooling mechanism 69 as a refrigerant for cooling the cooling plate 61 by heat of vaporization inside the refrigerant pipe.

In the example of FIG. 11, two battery cell stacks 5 are provided on the cooling plate 61. As described above, two battery cell stacks 5 are connected in a length direction, that is, the stacked direction of the rectangular battery cells 1, providing one battery cell stack continuous body 10B. Two battery cell stacks 5 in such a connection condition are supported by one cooling plate 61. The battery pack 10 includes these two battery cell stack continuous bodies 10B arranged in parallel.

Further, in the example of FIG. 11, the cooling plate 61 extends in the stacked direction of the rectangular battery cells 1, as well as the cooling pipe 60 provided thereinside meanders by being held back at an edge of the cooling plate 61. Therefore, the cooling pipe 60 formed into three lines is provided on under surfaces of the battery cell stacks 5. Then, by connecting the cooling pipes 60 each other in the battery cell stack continuous bodies 10B, a circulation path of the refrigerant is shared. When the plurality of battery cell stacks 5 are provided on the one cooling plate 61 to be cooled in this manner, the cooling mechanism can be shared, thereby providing a simplified cooling mechanism with lower price by sharing the cooling plate 61. Alternatively, a plurality of cooling pipes can be provided on the under surfaces of the battery cell stacks. For example, the meandering cooling pipe in FIG. 8 can be divided at held-back parts, providing a plurality of cooling pipes. Consequently, meandering parts can be eliminated, leading to weight reduction. At this time, the refrigerant path may be shared by connecting the cooling pipes each other. The configuration and the shape of the cooling pipe can be appropriately changed.

The cooling plate 61 also functions as heat equalizing means for equalizing temperatures of the plurality of rectangular battery cells 1. That is, the cooling plate 61 adjusts thermal energy absorbed from the rectangular battery cells 1 to efficiently cool the rectangular battery cell whose temperature increases, for example, the rectangular battery cell in the center. On the other hand, a region where the temperature decreases, for example, the rectangular battery cell at the end is cooled less, thereby reducing a difference in temperature among the rectangular battery cells. This enables reduction of temperature irregularity among the rectangular battery cells, and therefore, overcharge or overdischarge due to deterioration of some rectangular battery cells can be prevented.

Although FIG. 11 shows the example in which the cooling plate 61 is provided on the bottom surface of the battery cell stack 5, the configuration is not limited thereto. For example, the cooling plate can be provided on each side surface of the rectangular battery cell or only on one side surface thereof.

### (Cooling Pipe 60)

Further, the cooling pipe 60 allowing the inside refrigerant to pass through can be directly provided on the under surface of the battery cell stack 5 without a metal plate such as a cooling plate. That is, plural lines of cooling pipes 60 are provided on an under surface of the cover case 16 housing the battery cell stack 5, and further, a heat insulating member 14 is provided among the cooling pipes 60, as shown in the schematic sectional view of FIG. 12A. In such a manner, cooling by the cooling pipe 60 with high efficiency is achieved by eliminating air space around the cooling pipes 60, and insulating heat by covering with the heat insulating member. As a result of achieving the cooling with high efficiency in such a manner, a large number of cooling pipes is no longer required to be provided on the bottom surface of the battery cell stack unlike the conventional technique. A sufficient cooling effect is obtained even by a small number of two or three cooling pipes, leading to simplification of the cooling mechanism and weight reduction of the power supply apparatus. Further, according to this system, the cooling pipe allowing the refrigerant to pass through can directly come into contact with the battery cell stack 5 to cool the battery cell stack 5 without providing a metal plate such as a cooling plate. At this point, flattening, weight reduction, downsizing are also achieved.

As shown in FIG. 12A, the cooling pipe 60 is a flat type with an opposite surface to the battery cell stack flat, which can certainly achieve thermal coupling with the battery cell stack 5 by increasing a contact area with the rectangular battery cell 1, compared with the cylindrical cooling pipe. The cooling pipe 60 is made of a material having excellent thermal conductivity. Here, the cooling pipe 60 is made of metal such as aluminum. Since the cooling pipe made of aluminum is relatively flexible, a surface of the cooling pipe is slightly deformed by being pressed at a contact interface with the battery cell stack 5, thereby improving adhesion and achieving high thermal conductivity.

### (Thermal Conductive Sheet 12)

Further, a thermal conductive member such as a thermal conductive sheet 12 is provided between the cooling pipe 60 and the rectangular battery cells 1. The thermal conductive sheet 12 is made of a material having insulating properties and excellent thermal conductivity, and more preferably elasticity to some extent. Such a material includes acrylic-based, urethane-based, epoxy-based and silicone-based resin. The battery cell stack 5 and the cooling pipe 60 is electrically insulated each other in such a manner. When the outer can of the rectangular battery cell 1 and further the cooling pipe 60 are made of metal, insulation is particularly required in order not to bring them into conduction at the bottom surface of the rectangular battery cell 1. As described above, insulation is maintained by covering the surface of the outer can with a heat shrinkable tube or the like, and moreover, the insulating thermal conductive sheet 12 is provided for improving the insulating properties. Safety and reliability are therefore enhanced. Alternatively, conductive paste or the like can be used instead of the thermal conductive sheet. Further, an additional insulating film can be provided for certainly maintaining the insulating properties. Furthermore, the cooling pipe can be made of an insulating material. When the insulating properties are sufficiently maintained, the thermal conductive sheet or the like may be omitted.

With the elasticity of the thermal conductive sheet 12, the surface of the thermal conductive sheet 12 is elastically deformed to eliminate a gap at the contact surface between the battery cell stack 5 and the cooling pipe 60. Therefore, the thermal coupling can be favorably improved.

### (Heat Insulating Member 14)

In the power supply apparatus in FIG. 12A, the heat insulating member 14 is provided at gaps among the cooling pipes 60. The heat insulating member 14 can be a resin having heat insulating properties. For example, urethane-based resin or the like can be preferably used. Here, the circumference of the cooling pipe 60 is covered with the resin having heat insulating properties by potting, as shown in FIG. 12. Accordingly, the cooling pipes 60 and the bottom surface of the battery cell stack 5 are certainly covered by the potting, thereby preventing the generation of condensation and enhancing the safety.

In the example of FIG. 12A, the gaps among the cooling pipes 60, and the under surfaces of the cooling pipes 60 are covered with the applied heat insulating member 14, while the cooling pipes 60 are in contact with the bottom surface of the battery cell stack 5 via the thermal conductive sheet 12. If the heat insulating member 14 is applied on the top surface of the cooling pipe 60, the top surface of the cooling pipe 60 can be insulated. Therefore, the thermal conductive sheet provided between the rectangular battery cells 1 and the cooling pipe 60 can be no longer needed.

The description has been made on the case where the cover case 16 is a box type with its under surface opened and its top surface closed in the example of FIG. 12A. However, the cover case can be a closed-end box type with its top surface opened and its under surface closed, as described above. In this cover case, the bottom thereof may be a bottom plate obtained by insert-molding a metal plate, as shown in FIG. 7. The bottom plate is obtained by insert-molding a flat metal plate; besides, one strip-like metal plate or a plurality of strip-like metal plates can be insert-molded so as to be partially embedded. In this instance, as shown in the sectional view of FIG. 12B, the bottom plate is configured so that a metal plate 21c is provided at a position corresponding to the cooling pipe 60, thereby improving the thermal coupling with the cooling pipe 60.

In the power supply apparatus 100 according to Embodiment 1, the rectangular battery cell 1 is protected from the condensation or the like by tightly sealing the battery cell stack 5 and achieving the waterproof structure. According to this configuration, internal space can be identified by the inner case 21 and the end plates 3, and the cushioning member 18 is provided thereinside by the potting or the like, thereby achieving tight sealing. Since the end plate 3 is located outside, fixing to an outer case, a frame or the like can be advantageously performed easily. Further, since the fastening member 4 is located outside the inner case 21, a fixing structure for fixing the cooling plate 61 can be advantageously downsized.

Sufficient strength is imparted to the inner case using metal or the like, and therefore, the battery cell stack can also be fastened by fixing the end plate 3 to the inner case. With this configuration, further downsizing is achieved because the inner case can also serve as the fastening member.

### Embodiment 2

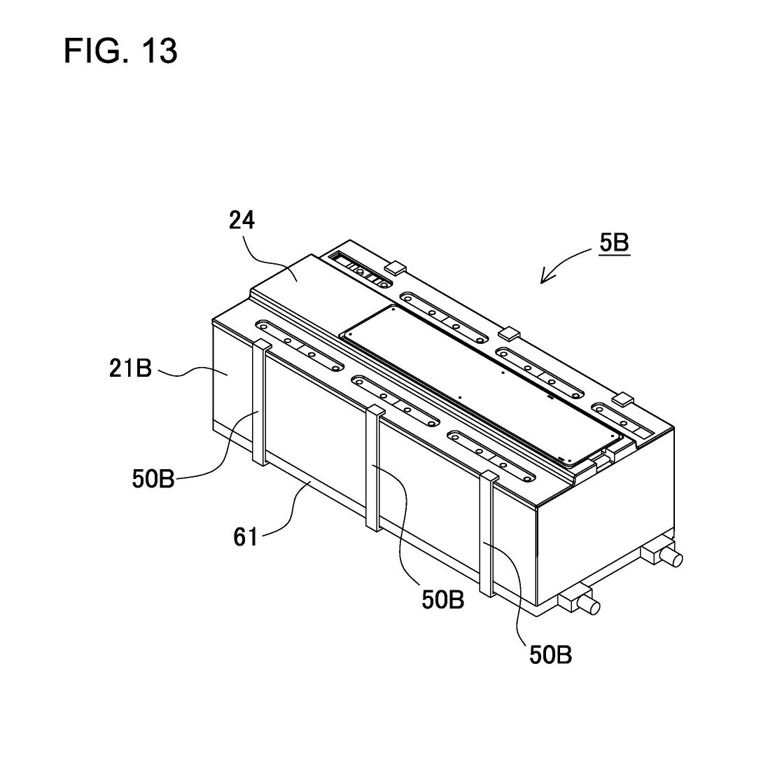

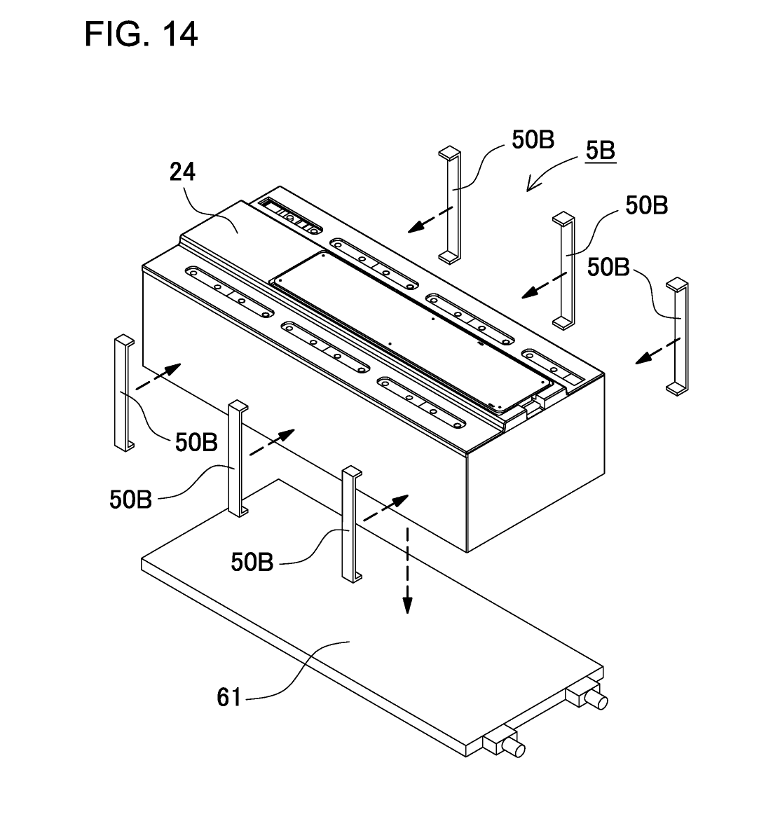

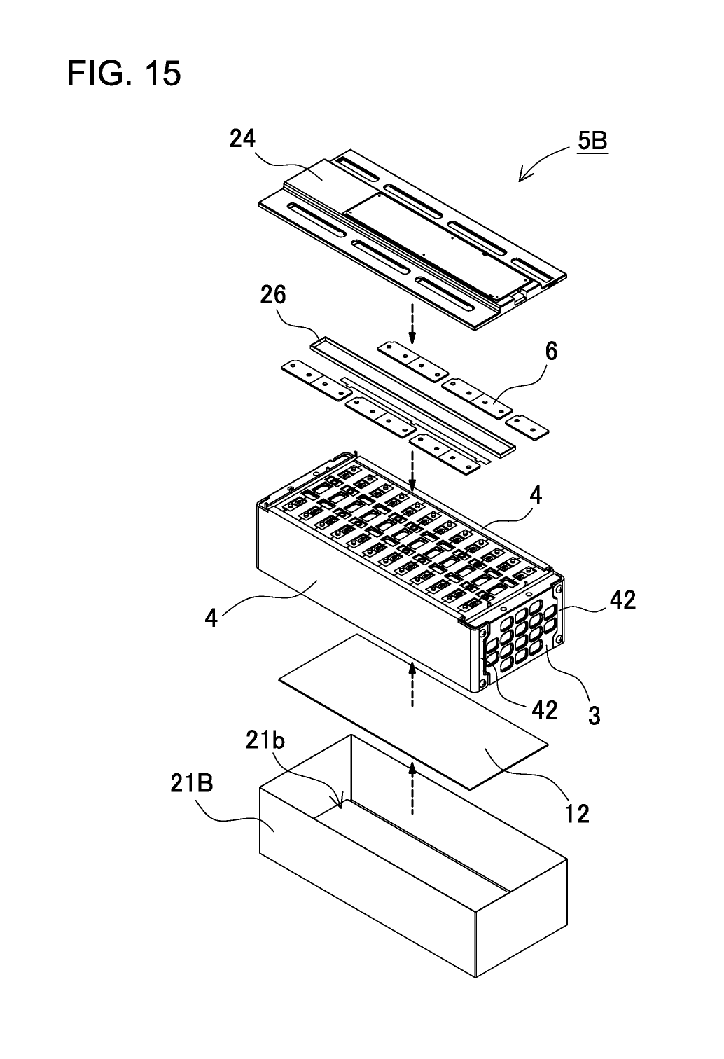

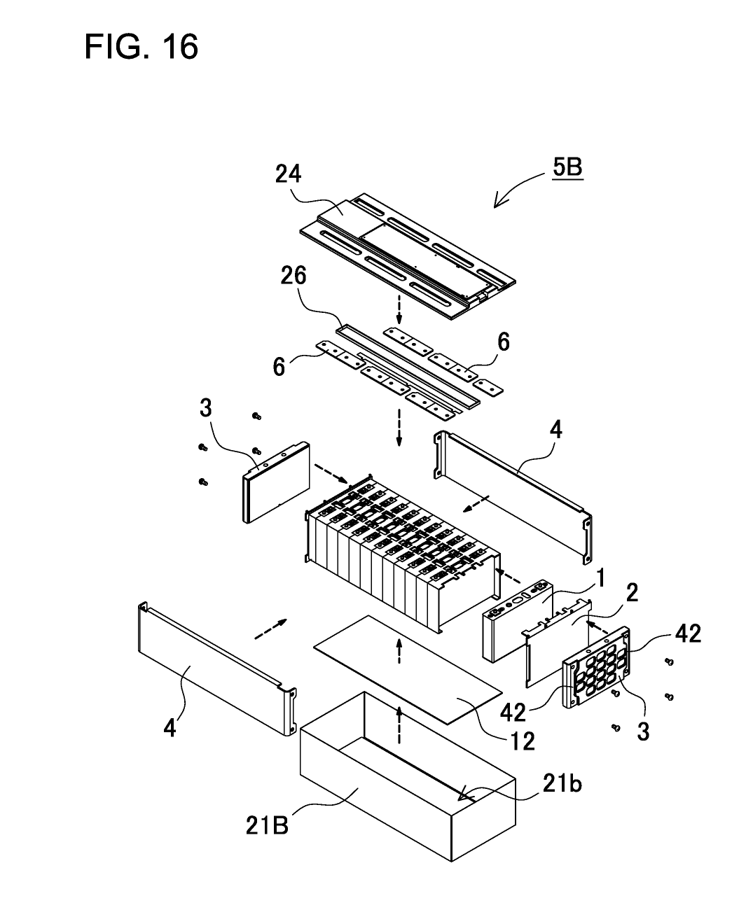

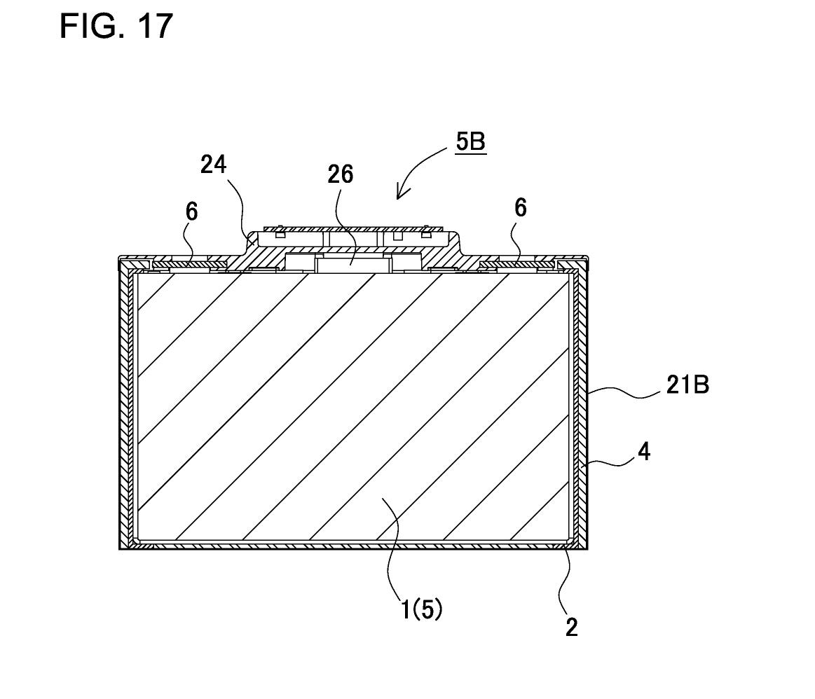

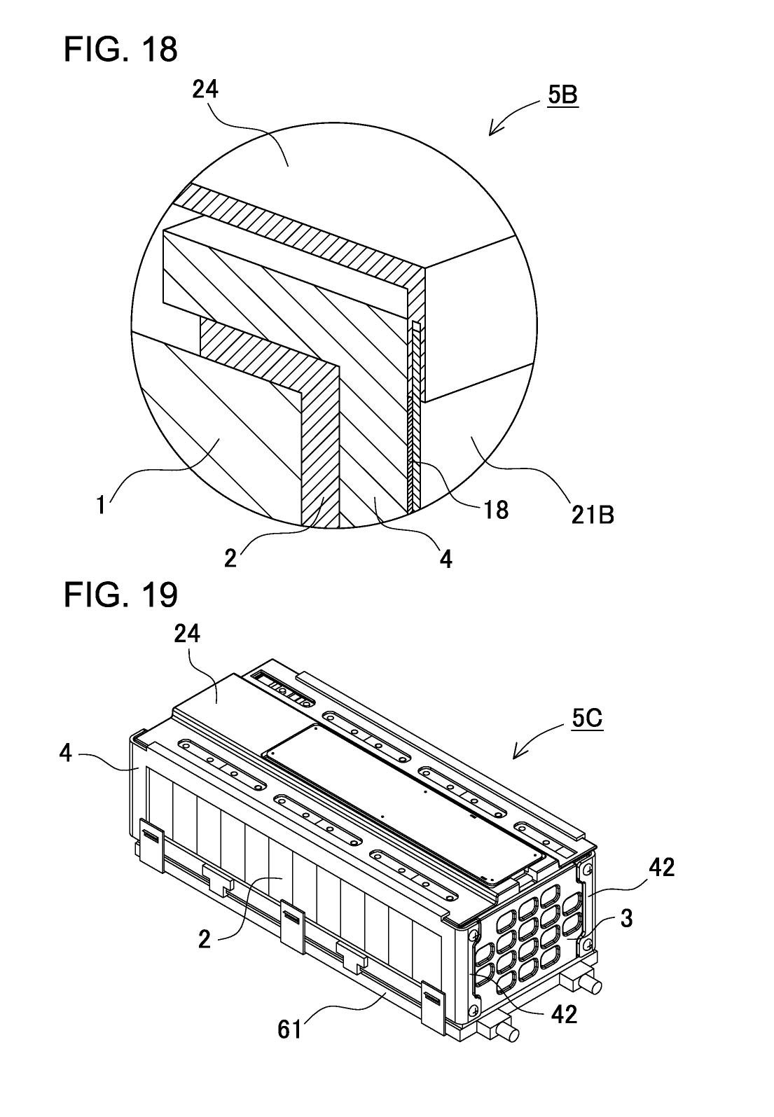

According to the configuration in Embodiment 1, the inner case provided between the battery cell stack and the fastening member needs to be newly designed. Therefore, an existing power supply apparatus cannot be used as it is. In order to use an existing battery cell stack and fastening member as well as achieve the waterproof structure, the inner case can be formed into a size large enough for housing the battery cell stack that has been fastened by the fastening member. Such a configuration will be described as Embodiment 2 with reference to FIGS. 13 to 18. In these figures, FIG. 13 is a perspective view of a battery cell stack 5B in a power supply apparatus according to Embodiment 2, FIG. 14 is an exploded perspective view illustrating the battery cell stack 5B in FIG. 13 having the cooling plate 61 removed therefrom, FIG. 15 is an exploded perspective view of the battery cell stack 5B in FIG. 14, FIG. 16 is an exploded perspective view of the battery cell stack 5B in FIG. 15, FIG. 17 is a vertical sectional view of the battery cell stack 5B in FIG. 13, and FIG. 18 is an enlarged perspective sectional view illustrating a connection part between an inner case 21B and the cover portion 24. A configuration of an outer case housing the battery cell stack 5B and the cooling plate 61 is nearly the same as that of in FIG. 1, and description is therefore omitted. The same members as those of in Embodiment 1 are represented by the same symbols, and therefore, detailed description is omitted.

As for the battery cell stack 5B, a circumference thereof is covered with the inner case 21B, and then, the cooling plate 61 is fixed to a bottom surface of the inner case 21B by connecting bars 50B shown in FIGS. 13 and 14. The connecting bar 50B is a metal plate extending in a vertical direction at a side surface of the inner case 21B with a section thereof U-shaped. The connecting bar 50B is engaged with a top surface of the inner case 21B and also with the bottom surface of the cooling plate 61, and then fixed by screwing or the like.

As for the bottom surface of the inner case 21B, the bottom plate 21b is also a metal plate for enhancing thermal coupling with the cooling plate 61. The cooling pipe 60 can also be used instead of the cooling plate 61, similarly to Embodiment 1.

The battery cell stack 5B is previously fastened by the fastening members 4 so that both ends thereof are sandwiched by the end plates 3 with rectangular battery cells 1 and the separators 2 alternately stacked. The fastening member 4 is formed by bending a metal plate having an excellent fastening force. The end of the rectangular battery cell 1 is covered with the separator 2 in case the rectangular battery cells 1 should be brought into conduction each other due to the fastening member 4 of the metal plate. Then, the battery cell stack 5B fastened by the fastening members 4 is housed in the inner case 21B, as shown in FIGS. 15 and 16. At this time, the thermal conductive sheet 12 is preferably provided between the bottom surface of the battery cell stack 5B and the bottom plate 21b of the inner case 21B. By deforming a surface of the thermal conductive sheet 12, a gap between the battery cell stack 5B and the bottom plate 21b is reduced, thereby improving the thermal coupling. Further, the cushioning member 18 is inserted in a gap between the battery cell stack 5B and the inner case 21B. For example, the gap is filled with a potting material such as a urethane-based resin. Furthermore, a top surface of the inner case 21B is blocked by the cover portion 24. By providing an inlet on the cover portion, the gap can also be filled with the potting material after the inner case is blocked by the cover portion in advance. In this instance, a gap between the cover portion and the battery cell stack can also be advantageously filled. As shown in the sectional view of FIG. 17, the rectangular battery cell 1 is covered in this manner, thereby enabling prevention of condensation on the surface. More specifically, as shown in the enlarged perspective view of FIG. 18, the surface of the rectangular battery cell 1 is covered with the separator 2 and the fastening member 4, and further, the cushioning member 18 is provided between the fastening member 4 and the inner case 21B. A water absorption sheet or the like can be used as the cushioning member 18, as described above. The gas duct 26 communicating with a gas outlet of the safety valve of the rectangular battery cell 1 is provided on an inner surface of the cover portion 24.

### Embodiment 3

According to the above configuration, an existing battery cell stack can be housed in the inner case, followed by potting or the like, thereby easily achieving the waterproof structure.

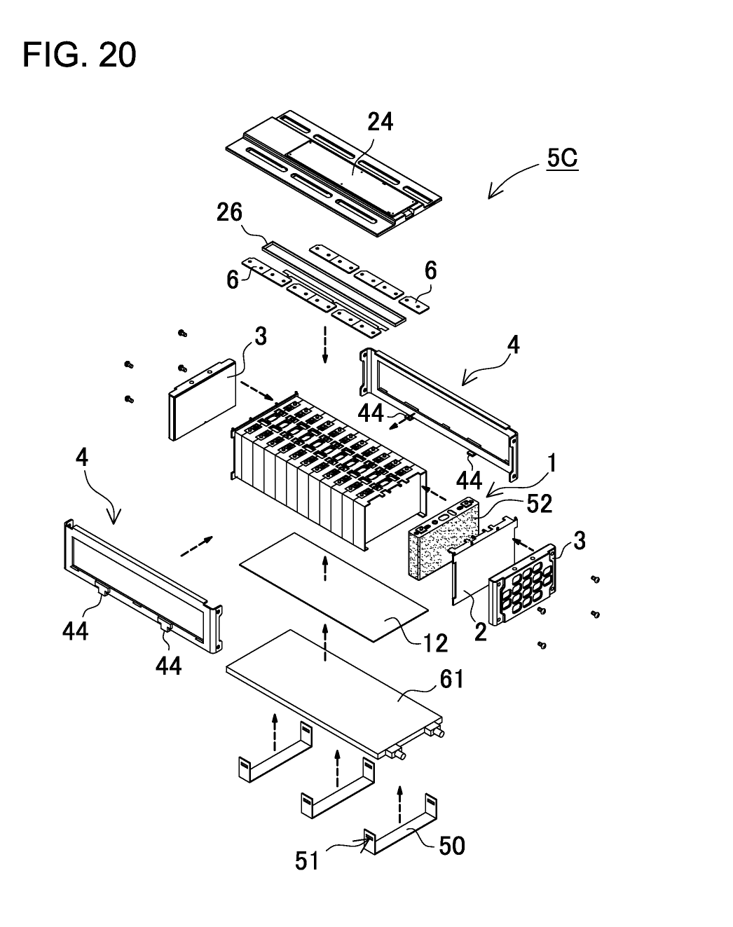

Meanwhile, a part where there is a high probability of forming condensation is a contact surface with the cooling plate. Then, if not the whole battery cell stack but only the contact surface with the cooling plate or the vicinity thereof is covered with the cushioning member, downsizing is achieved. Such an example is shown as Embodiment 3 in FIGS. 19 to 20. In these figures, FIG. 19 is a perspective view of a battery cell stack 5C according to Embodiment 3, and FIG. 20 is an exploded perspective view of FIG. 19. In this battery cell stack 5, a circumference thereof is not completely blocked for the waterproof structure. Only a bottom surface of the contact surface with the cooling plate 61 is covered with the cushioning member 18.

### (Heat Shrinkable Tube)

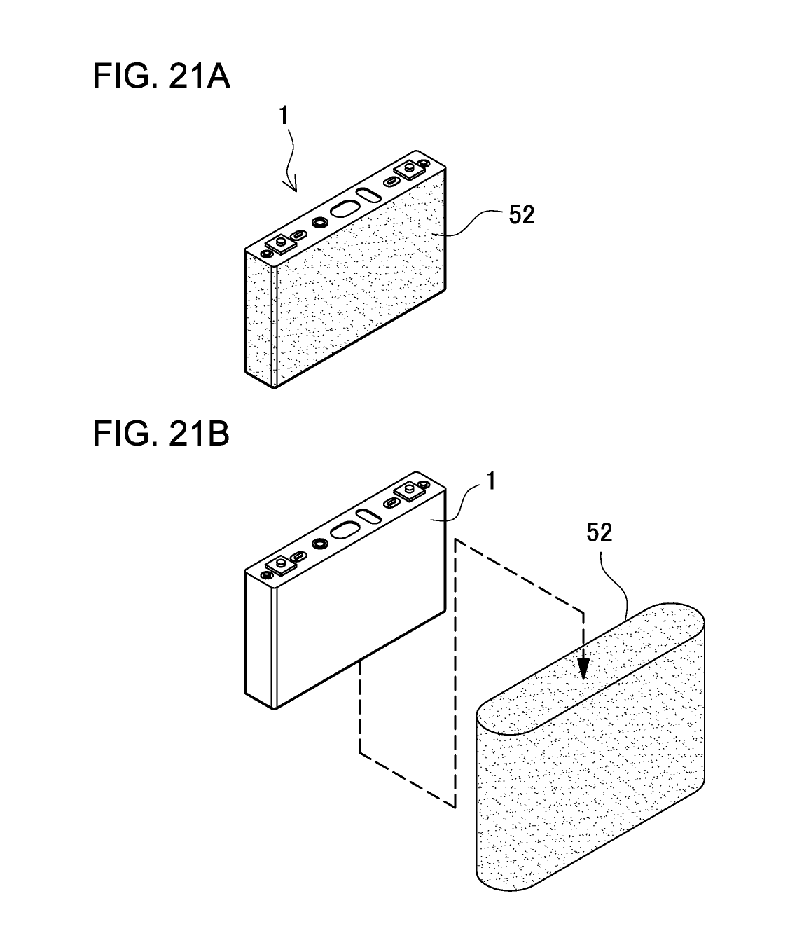

As shown in FIG. 21A, 21B, a side surface of the outer can is covered with a cylindrical heat shrinkable tube 52 in each rectangular battery cell 1. In other words, a top surface and a bottom surface of the outer can are not covered with the heat shrinkable tube 52. With this configuration, labor saving is significantly achieved in a covering operation. That is, conventionally, the rectangular battery cell is inserted in a bag shaped heat shrinkable tube mainly by hand, followed by heating and shrinking the heat shrinkable tube. Further, attention needs to be paid in case an edge of the melted heat shrinkable tube projects at the bottom surface or the outer can of the rectangular battery cell is exposed, leading to a difficult operation with caution. On the other hand, according to the present embodiment, what is only required is to cover the side surface of the rectangular battery cell 1 with the cylindrical heat shrinkable tube 52. Therefore, such an operation can be significantly simplified. Moreover, conventionally, a melted part of the heat shrinkable tube is provided between the bottom surface of the rectangular battery cell and the cooling plate 61 because the melted part projects at the bottom surface of the rectangular battery cell, mainly causing a bad contact condition. However, such a problem is solved by eliminating the heat shrinkable tube. Therefore, efficiency of the thermal coupling can be advantageously increased with the bottom surface of the outer can kept flat.

Similarly to the above, these rectangular battery cells are stacked via the separators 2 and the pair of end plates 3 is provided at the ends to be fastened by the fastening members 4, thereby providing the battery cell stack 5C. As shown in FIG. 20, the bottom surface of the battery cell stack 5C is covered with the cushioning member 18 with the bottom surfaces of the rectangular battery cells 1 exposed. Here, a gap of the bottom surface of the battery cell stack 5C is filled with a potting material by dipping the bottom surface in a potting layer storing the potting material, and then the resin is cured. After that, the battery cell stack 5C is provided on the cooling plate 61 via the thermal conductive sheet 12 to be fixed thereto.

Alternatively, the battery cell stack is previously provided on the cooling plate via the thermal conductive sheet to be fixed before being covered with the cushioning member, and thereafter, the cushioning member can be provided. That is, the filling material is poured in for filling with the cooling plate previously connected to the battery cell stack. Therefore, the gap between the cooling plate and the battery cell stack can be filled with the filling material. Consequently, the thermal coupling can be more certainly performed between the cooling plate and the battery cell stack without a gap.

As described above, a top surface of the battery cell stack 5C is blocked by the cover portion 24. Additionally, the top surface is water tightly sealed via an elastic body, as required.

According to this configuration, an amount of resin necessary for potting can be advantageously reduced, leading to production in a short time with low cost. Further, a circumference of the battery cell stack 5C can have the waterproof structure by covering it with resin by dipping, while the inner case is not necessarily required.

Although the configuration in which the bottom surface of the battery cell stack is made waterproof is not limited to the above, various aspects can be appropriately employed. For example, a water absorption sheet is provided on the contact surface between the battery cell stack and the cover case 16. Consequently, the bottom surface of the battery cell stack can be made waterproof by causing the water absorption sheet to absorb formed condensation. Alternatively, the cover case is formed with a pair of side plates covering the side surfaces of the battery cell stack, the pair of end plates 3 covering the ends, the cover portion 24 covering the top surface, and the bottom plate 21b covering the bottom surface. The battery cell stack can also be made waterproof by fitting these members to each other and making a connection surface waterproof with packing or the like. In addition to the configuration in which respective surfaces of the cover case are formed with individual members, a part or a whole part may be integrally formed with resin, metal or the like.

Further, the bottom plate may be formed with a cooling plate. In addition to the cooling plate, the bottom surface of the cover case may be covered with a thermal conductive sheet or another sheet material, or a plate.

### Embodiment 4

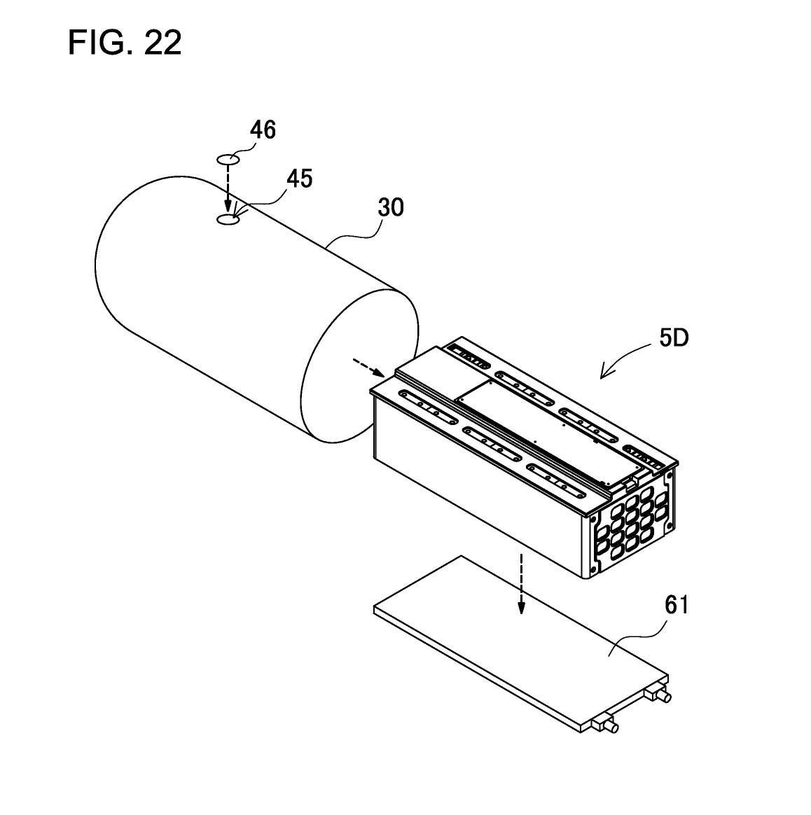

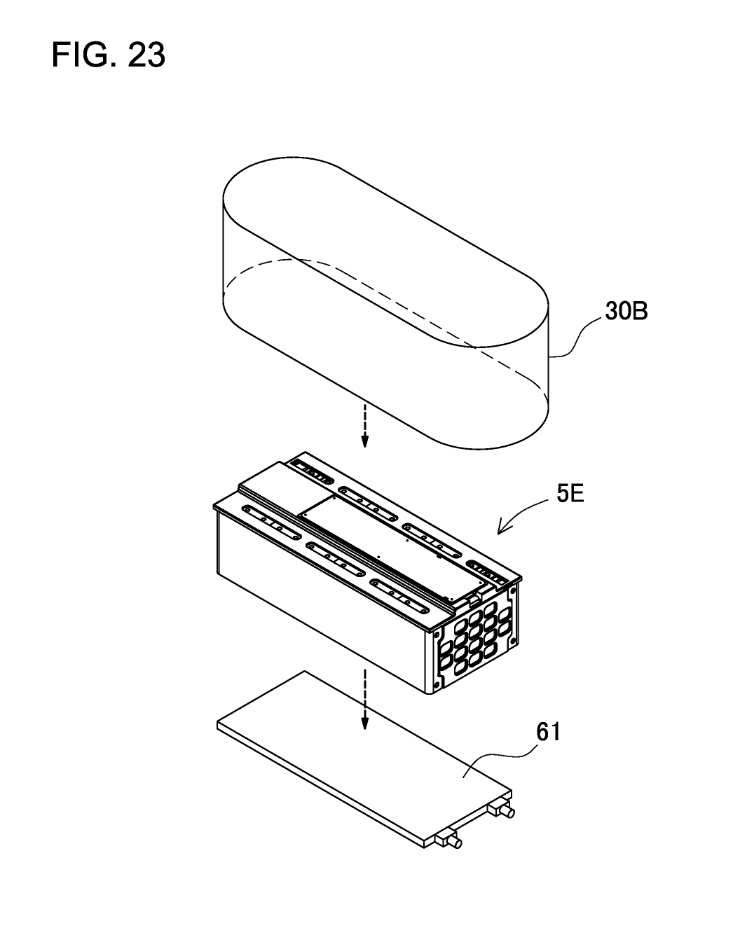

The side surfaces or the whole of the battery cell stack can be covered with a waterproof bag. This configuration will be described as Embodiments 4 and 5 with reference to FIGS. 22 and 23. In an example of FIG. 22, a battery cell stack 5D fastened by the fastening members 4 is inserted in a waterproof bag 30 in a bag shape, followed by sealing the waterproof bag 30. The waterproof bag 30 therefore physically prevents a water drop from entering, achieving a waterproof structure of the battery cell stack 5D.

### (Waterproof Bag 30)

The waterproof bag 30 is obtained by forming a flexible sheet into a bag shape, as shown in FIG. 22. A plastic sheet can be used as the flexible sheet of the waterproof bag 30. The plastic sheet can include polyethylene (PE), polyimide (PI), polyethyleneimide (PEI), or polyethylene terephthalate (PET). These plastic sheets are excellent in flexibility and heat resistance. Further, these plastic sheets do not melt or cause a chemical reaction due to an electrolytic solution discharged when a safety valve of the rectangular battery cell 1 is opened. However, another plastic sheet can also be used as the flexible sheet.

### Embodiment 5

In Embodiment 5 shown in FIG. 23, a waterproof bag 30B is formed into a band shape, with which side surfaces of a battery cell stack 5E are covered. Further, a bottom surface of the battery cell stack 5E is covered with a resin. According to this configuration, the side surfaces of the battery cell stack 5E is covered and made waterproof with low cost and, as to the bottom surface, a gap is filled with the resin. Consequently, condensation can be certainly prevented.

### (Air Permeable Waterproof Sheet 46)

In the above waterproof structure, an opening can be provided on a part, while the opening part can be blocked by an air permeable waterproof sheet 46. The air permeable waterproof sheet 46 is made of a material having air permeability but not water permeability such as Gore-Tex (trademark). As an example in FIG. 22, a circular vent 45 is provided on a part of the waterproof bag 30, which circular vent 45 is blocked by the air permeable waterproof sheet 46. An adhesive is applied on one surface of the air permeable waterproof sheet 46 that can be stuck on like a sticker. Even when gas is generated in the waterproof bag 30, providing the vent 45 in such a manner allows gas to be released outside from the vent 45. When an internal pressure of the outer can particularly in the rectangular battery cell increases due to overcharge or overdischarge, the safety valve is opened to release the gas inside thereof. Therefore, the waterproof bag 30 may expand when the rectangular battery cell is tightly sealed with the waterproof bag 30. The expansion of the waterproof bag 30 can be prevented by providing the vent 45, and further, water entering from the vent 45 can also be prevented by the air permeable waterproof sheet 46. In other words, a sealing structure of the waterproof bag 30 employs not air-tight sealing but water-tight sealing, and therefore, the gas in the rectangular battery cell is allowed to be released by securing the air permeability together with achieving the protection of the rectangular battery cell according to the waterproof structure.

The vent 45 is preferably provided on a part opposite to a part on which a circuit board 6 is placed in the battery cell stack 5D. By providing in such a manner, the circuit board 6 is prevented from being directly exposed to water vapor, thereby maintaining waterproof properties even if a minute amount of water vapor enters via the air permeable waterproof sheet 46.

The power supply apparatus described above can be used for a vehicle-mounted battery system. As a vehicle having a power supply apparatus mounted, electric vehicles can be utilized, for example, hybrid automobiles or plug-in hybrid automobiles driven by both an engine and a motor, or electric automobiles only driven by a motor. The power supply apparatus can be used for power supplies of these vehicles.

### (Power Supply Apparatus for Hybrid Automobile)

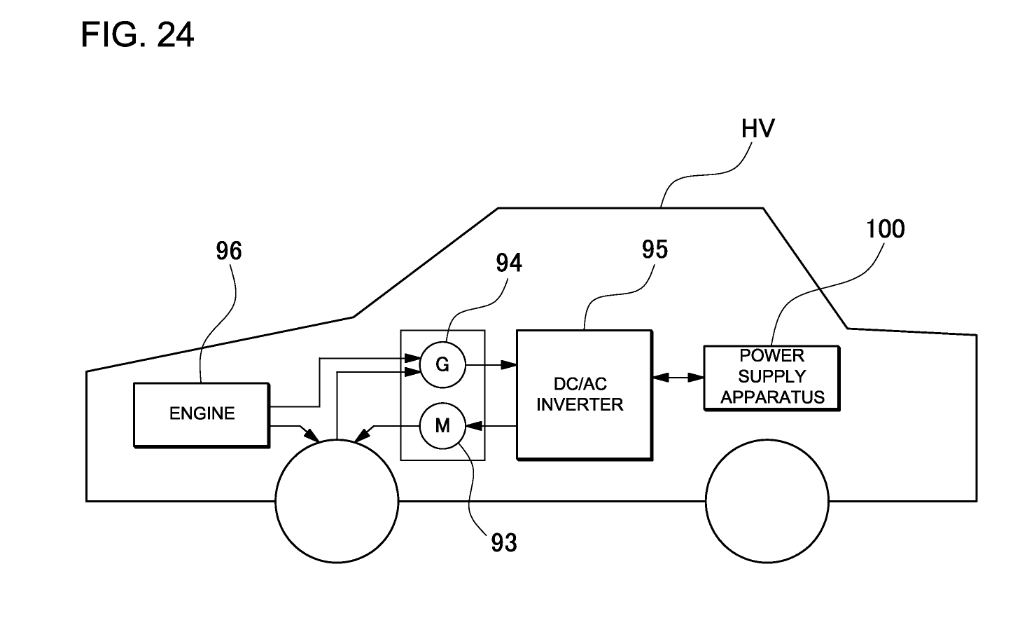

FIG. 24 illustrates an example in which a power supply apparatus is mounted on a hybrid automobile driven by both an engine and a motor. A vehicle HV in the figure having a power supply apparatus mounted thereon includes an engine 96 and a drive motor 93 that drive the vehicle HV, the power supply apparatus 100 supplying electric power to the motor 93, and a generator 94 charging a battery of the power supply apparatus 100. The power supply apparatus 100 is connected to the motor 93 and the generator 94 via a DC/AC inverter 95. The vehicle HV is driven by both the motor 93 and the engine 96 while the battery of the power supply apparatus 100 is charged and discharged. The motor 93 is driven in a region with low efficiency of the engine, for example, at the time of acceleration or driving at a low speed to drive the vehicle. The motor 93 is driven by having electric power supplied from the power supply apparatus 100. The generator 94 is driven by the engine 96 or regenerating braking at the time of braking the vehicle to charge the battery of the power supply apparatus 100.

### (Power Supply Apparatus for Electric Automobile)

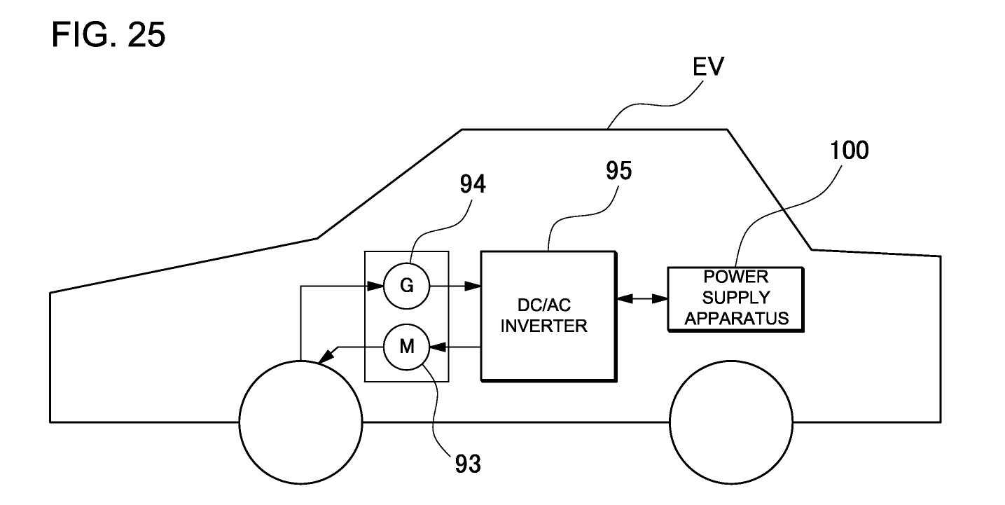

FIG. 25 also illustrates an example in which a power supply apparatus is mounted on an electric automobile only driven by a motor. A vehicle EV in the figure having a power supply apparatus mounted thereon includes the drive motor 93 driving the vehicle EV, the power supply apparatus 100 supplying electric power to the motor 93, and the generator 94 charging a battery of the power supply apparatus 100. The motor 93 is driven by having electric power supplied from the power supply apparatus 100. The generator 94 is driven by energy at the time of regenerating braking of the vehicle EV to charge the battery of the power supply apparatus 100.

### (Power Supply Apparatus for Storage of Electricity)

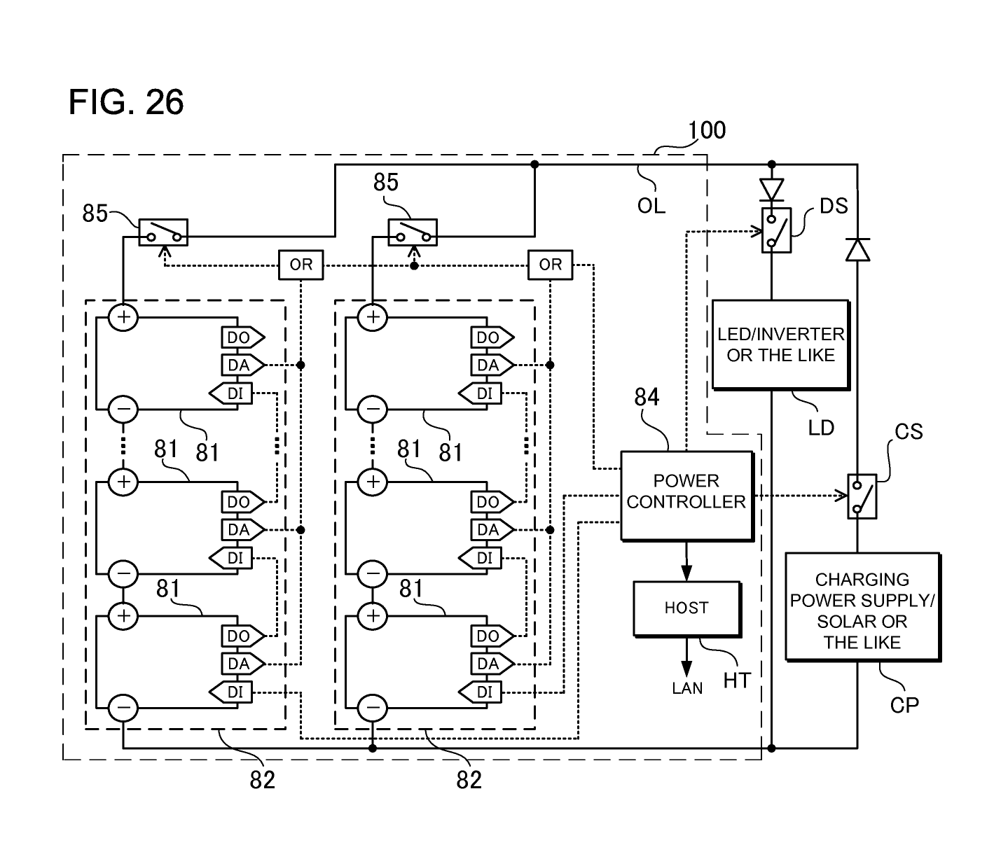

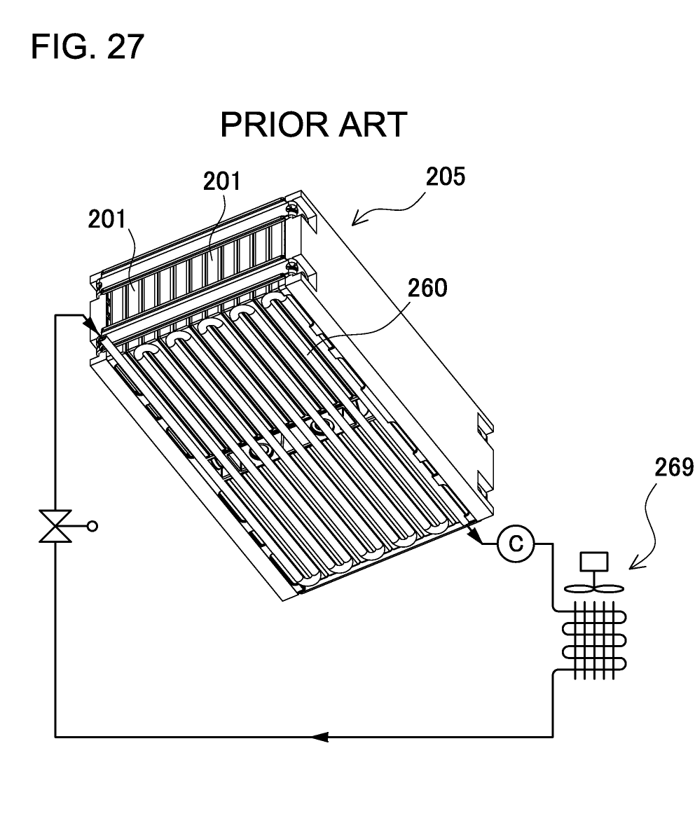

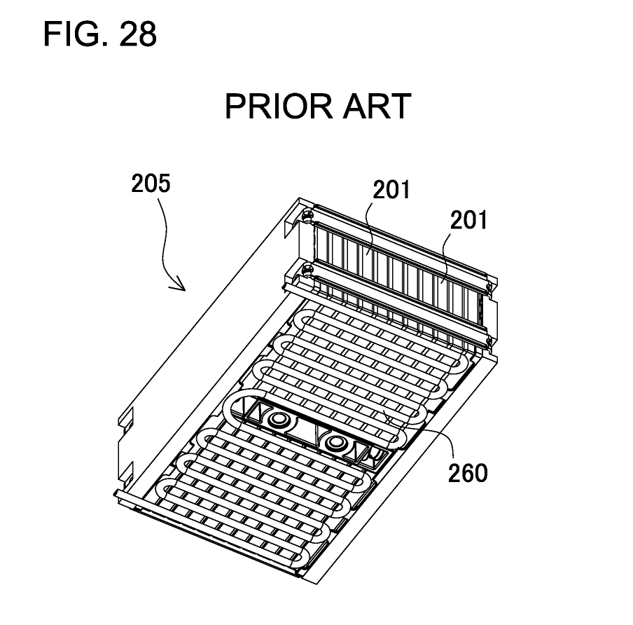

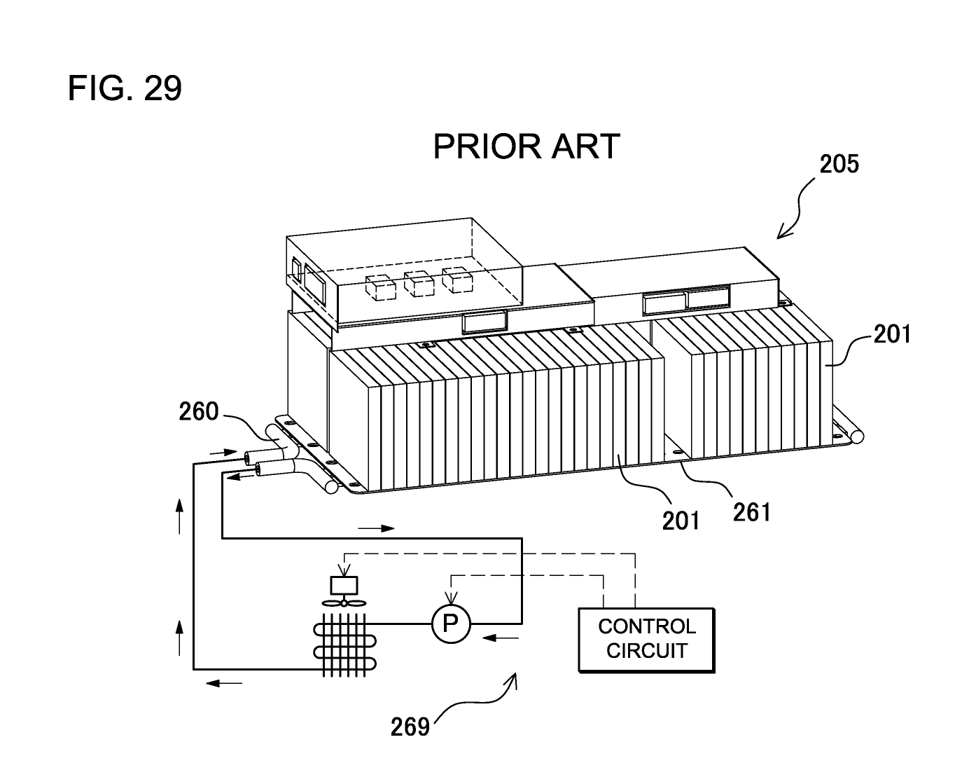

Further, the power supply apparatus can be used not only as a power source for movable bodies but also as installation-type equipment for storage of electricity. For example, the power supply apparatus can be used for a power supply system, as a power supply for household use or industrial use, in which charging is performed with electric power from photovoltaic power generation, night-time electric power, or the like and discharging is performed as required; a power supply for a streetlight performing charging with electric power from photovoltaic power generation during the daytime and performing discharging at nighttime; a backup power supply for a signal driven at the time of a power failure; or the like. FIG. 26 illustrates such an example. As for the power supply apparatus 100 in the figure, a battery unit 82 is formed by connecting a plurality of battery packs 81 in a unit form. Each of the battery packs 81 has a plurality of rectangular battery cells 1 connected in series and/or in parallel. Each of the battery packs 81 is controlled by a power controller 84. The power supply apparatus 100 causes a charging power supply CP to charge the battery unit 82 and then drives a load LD. The power supply apparatus 100 therefore includes a charging mode and a discharging mode. The load LD and the charging power supply CP are connected to the power supply apparatus 100 via a discharging switch DS and a charging switch CS, respectively. The power controller 84 of the power supply apparatus 100 switches ON/OFF of the discharging switch DS and the charging switch CS. In the charging mode, the power controller 84 switches the charging switch CS ON and the discharging switch DS OFF, permitting charging from the charging power supply CP to the power supply apparatus 100. When the charging is completed to be in a full charged condition or the charging is performed up to a capacity more than a predetermined value, according to a requirement from the load LD, the power controller 84 switches to the discharging mode by switching the charging switch CS OFF and the discharging switch DS ON, thereby permitting discharging from the power supply apparatus 100 to the load LD. Power supply to the load LD and charging to the power supply apparatus 100 can also be performed simultaneously by switching the charging switch CS ON and the discharging switch DS ON, as required.

The load LD driven by the power supply apparatus 100 is connected to the power supply apparatus 100 via the discharging switch DS. In the discharging mode of the power supply apparatus 100, the power controller 84 switches the discharging switch DS ON to connect the power supply apparatus 100 to the load LD, causing the load LD to drive by electric power from the power supply apparatus 100. A switching element such as FET can be used as the discharging switch DS. The power controller 84 of the power supply apparatus 100 controls ON/OFF of the discharging switch DS. The power controller 84 includes a communication interface for communicating with external equipment. In the example of FIG. 26, the power controller 84 is connected to a host apparatus HT according to an existing communication protocol such as UART or RS-232C. A user interface for a user operation with respect to a power supply system can also be provided, as required.

Each of the battery packs 81 includes a signal terminal and a power terminal. The signal terminal includes a pack input/output terminal DI, an abnormal pack output terminal DA and a pack connection terminal DO. The pack input/output terminal DI is for inputting and outputting a signal from another battery pack or the power controller 84, while the pack connection terminal DO is for inputting and outputting a signal with respect to another battery pack of a slave pack. The abnormal pack output terminal DA is for outputting an abnormality of the battery pack to an outside. Further, the power terminal is for connecting the battery packs 81 each other in series or in parallel. The battery units 82 are connected to an output line OL via switches 85 for parallel connection to be connected to each other in parallel.

The power supply apparatus and the vehicle having the same according to the present invention can be preferably used for a power supply apparatus for plug-in hybrid automobiles capable of switching an EV driving mode and a HEV driving mode, hybrid automobiles, electric automobiles or the like. The power supply apparatus can also be appropriately used for various applications such as for a backup power supply apparatus mountable on a rack of a computer server, a backup power supply apparatus for a radio base station of a mobile phone or the like, a power supply for storage of electricity for household use or industrial use, a power supply for a street light or the like, an electrical storage apparatus in combination with a solar battery cell, and a backup power supply of a signal or the like.

1-10. (canceled)

11. A power supply apparatus, comprising:
a battery cell stack obtained by stacking a plurality of battery cells; and
a cover case surrounding an outside of the battery cell stack,
wherein a resin is poured between the battery cell stack and the cover case, achieving a waterproof structure of making the battery cell stack waterproof.

12. The power supply apparatus according to claim 11, wherein the resin is a urethane-based resin.

13. A power supply apparatus, comprising:
a battery cell stack obtained by stacking a plurality of battery cells; and
a cover case surrounding an outside of the battery cell stack,
wherein the battery cell stack is inserted into a waterproof bag having waterproof properties, followed by sealing the waterproof bag, thereby achieving a waterproof structure of making the battery cell stack waterproof.

14. The power supply apparatus according claim 11, wherein an opening is provided on a part, while the opening is blocked by an air permeable waterproof sheet having air permeability and waterproof properties, thereby achieving the waterproof structure.

15. The power supply apparatus according to claim 11, wherein the cover case includes a plurality of case members and each case member is provided with a fitting portion for airtightly sealing the case members each other.

16. The power supply apparatus according to claim 15, wherein the fitting portion is sealed by a packing, an O-ring or a gasket.

17. A power supply apparatus, comprising:
a battery cell stack obtained by stacking a plurality of rectangular battery cells; and
a cover case surrounding an outside of the battery cell stack,
wherein a water absorption sheet having water-absorbing properties is provided between the battery cell stack and the cover case.

18. The power supply apparatus according to claim 11, further comprising:
a cooling plate provided on one surface of the battery cell stack to be thermally coupled with the battery cell stack, the cooling plate performing heat exchange with the battery cell stack by flowing a refrigerant thereinside.

19. The power supply apparatus according to claim 18, further comprising:
a thermal conductive sheet provided between one surface of the battery cell stack and the cooling plate, the thermal conductive sheet having insulating properties.

20. A vehicle having the power supply apparatus according to claim 11 mounted thereon.
